(19) United States
(12) Patent Application Publication
(10) Pub. No.: US 2008/0233856 A1
(43) Pub. Date: Sep. 25, 2008

(54) Air conditioner duct

(75) Inventors: Shintarou OKAWA, Aichi-ken (JP); Nobuhiro TERAI, Aichi-ken (JP); Takahiko SATO, Aichi-ken (JP); Yoshikazu HIROSE, Aichi-ken (JP); Katsuhiro KATAGIRI, Aichi-ken (JP); Minoru SHIBATA, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/076,449

(22) Filed: Mar. 19, 2008

(30) Foreign Application Priority Data
Mar. 22, 2007 (JP) 2007-075232
Jul. 30, 2007 (JP) 2007-197651
Sep. 14, 2007 (JP) 2007-239527

(51) Int. Cl. B60H 1/00; F01N 1/00

(52) U.S. Cl. 454/143; 181/224

(57) ABSTRACT

An air conditioner duct connected to a downstream side of an air flow path of a vehicular air conditioning apparatus is provided with an outer pipe portion and an inner pipe portion formed at an inner portion of the outer pipe portion, a first inner end of the inner pipe portion is integrated to an inner peripheral face of the outer pipe portion, an outer peripheral face of a second inner end of the inner pipe portion and an inner peripheral face of the outer pipe portion are separated, a side branch type noise suppressing chamber is defined by the inner peripheral face of the outer pipe portion and the outer peripheral face of the inner pipe portion, and the outer pipe portion is provided with an adjusting portion continuous to an upstream side of an air flow path of the first inner end.

### BACKGROUND OF THE INVENTION

1. Field of the Invention

The present invention relates to an air conditioner duct connected to a downstream side on an air flow path of a vehicular air conditioning apparatus for guiding air flowing out from the vehicular air conditioning apparatus in a predetermined direction.

2. Related Art

An air conditioner duct connected to a vehicular air conditioning apparatus (so-to-speak air conditioner) is constituted by a tubular shape. Air blown out from the vehicular air conditioning apparatus flows through an inner portion of the air conditioner duct. Therefore, noise derived from the vehicular air conditioner apparatus is transmitted to the air conditioner duct. In order to reduce the noise, there is a technology of providing a resonating apparatus of a resonator, a side branch or the like to the air conditioner duct. However, a general resonator or the side branch is considerably projected to an outer side of the air conditioner duct. Therefore, the air conditioner duct provided with a general resonator or a side branch is significantly large-sized. Therefore, depending on a vehicle, there is a case in which a space for mounting the air conditioner duct of this kind cannot be ensured.

It is conceived that the significant large-sized formation of the air conditioner duct can be restrained when a slit resonator is adopted as the resonator for the air conditioner duct (for example, refer to JP-A-2006-335125). However, even in the air conditioner duct introduced in JP-A-2006-335125, depending on a frequency band constituting a restraining object, there is a case in which an expanded chamber of the resonator is considerably projected to an outer peripheral side of the air conditioner duct. This is due to the following reason.

It is known that a frequency (resonance frequency) of noise restrained by a slit resonator is determined by a volume V4 of a resonating box portion 900, a length 14 of a communicating pipe 901, and a radius r4 of the communicating pipe 901 shown in FIG. 21. Therefore, the length 14 of the communicating pipe 901 of the slit resonator is determined in accordance with a frequency of noise constituting the restraining object. Meanwhile, when the frequency of the noise constituting the restraining object is small, as shown by FIG. 22, it is necessary to prolong the length 14 of the communicating pipe 901. In this case, the resonating box portion 900 is considerably projected to an outer peripheral side of the air conditioner duct, and therefore, the air conditioner duct is large-sized.

There is also a technology of reducing noise without making a suction duct large-sized by providing a portion functioning as a side branch or a resonator at an inner portion of the suction duct (refer to, for example, JP-A-2001-248508).

FIG. 23 shows a drawing schematically showing a suction duct introduced in JP-A-2001-248508. As shown by FIG. 23, the suction duct introduced in JP-A-2001-248508 is constituted by integrating an outer duct 106 constituting a tubular shape, a narrowed duct 104 constituting a tubular shape and provided on an inner peripheral side of the outer duct 106. A length in an axial direction of the narrowed duct 104 is shorter than a length in the axial direction of the outer duct 106. Further, an end portion 140 on an upstream side of an air flow path of the narrowed duct 104 is integrated to an inner peripheral side of the outer duct 106. The narrowed duct 104 is provided with a narrowest portion 144 having a partially small radial cross-sectional area at a portion thereof in the axial direction.

According to the suction duct introduced in JP-A-2001-248508, noise can be reduced by utilizing a space between the narrowed duct 104 and the outer duct 106 as a side branch type noise suppressor. In details, an end portion 142 on the downstream side of the air flow path of the narrowed duct 104 and the inner peripheral face of the outer duct 106 are separated. Therefore, noise propagating the suction duct advances to an inner portion (that is, a space partitioned to be formed between the inner peripheral face of the outer duct 106 and the outer peripheral face of the narrowed duct 104) of the side branch type noise suppressor by passing a gap (hereinafter, referred to as an opening end face 180). Therefore, according to the suction duct introduced in JP-A-2001-248508, noise can be reduced.

When the technology introduced in JP-A-2001-248508 is applied to the air conditioner duct, there is a possibility of capable of reducing noise without making the air conditioner duct large-sized.

However, according to the suction duct introduced in JP-A-2001-248508, the end portion 140 on the upstream side of the air flow path of the narrowed duct 104 is integrated to an end portion on an upstream side of an air flow path (hereinafter, referred to as a flow inlet 150) of the outer duct 106. Therefore, when the suction duct introduced in JP-A-2001-248508 is applied to the air conditioner duct and a vehicular air conditioning apparatus is attached to the flow inlet 150, as shown by FIG. 23, air flowing out from the vehicular air conditioning apparatus flows abruptly into the narrowed duct 104. Therefore, in this case, a turbulent flow is generated at the narrowed duct 104. When the turbulent flow is generated at the narrowed duct 104, an amount of air flowing in parallel with an opening end face 180 is increased, and therefore, a whistling sound is generated. Further, when the turbulent flow is generated in the narrowed duct 104, there also poses a problem that a pressure loss of air flowing through the air conditioner duct is increased.

Further, according to the suction duct introduced in JP-A-2001-248508, it is difficult to reduce sufficiently noise of a frequency band constituting a restraining object (hereinafter, referred to as restraining object sound). This is due to the following reason.

A frequency of noise which can be reduced by the side branch type noise suppressor is determined in accordance with a pipe length of the side branch type noise suppressor. On the other hand, in order to sufficiently reduce the restraining object sound, it is preferable to provide an opening end face of the side branch type noise suppressor at a position of the duct at which a sound pressure of the restraining object sound becomes the largest (loop of sound pressure). For example, in order to reduce a restraining object sound of a low frequency, it is preferable to prolong the pipe length (that is, arrange opening end face on the downstream side of the air flow path). In order to reduce a restraining object sound of a high frequency, it is preferable to shorten the pipe length (that is, opening end face is arranged on the upstream side of the air flow path).

Meanwhile, according to the suction duct introduced in JP-A-2001-248508, the end portion 140 on the upstream side of the air flow path of the narrowed duct 104 is integrated with the flow inlet 150 of the outer duct 106. Therefore, according to the suction duct introduced in JP-A-2001-248508, there is a case in which a pipe length 15 of the side branch type noise suppressor set in accordance with a frequency of the restraining object sound and a loop of a sound pressure do not coincide with each other. Therefore, according to the suction duct introduced in JP-A-2001-248508, it is difficult to sufficiently reduce the restraining object sound.

Further, the flow inlet of the suction duct introduced in JP-A-2001-248508 is constituted by a complicated shape, and therefore, it is very difficult to accurately form the suction duct introduced in JP-A-2001-248508. Also thereby, according to the suction duct introduced in JP-A-2001-248508, it is difficult to sufficiently reduce restraining object sound.

### SUMMARY OF THE INVENTION

The invention has been carried out in view of the above-described situation and it is an object thereof to provide an air conditioner duct capable of restraining a turbulent flow from being generated and capable of sufficiently reducing a restraining object sound without being bulky.

An air conditioner duct of the invention resolving the above-described problem is characterized in including an outer pipe portion connected to a downstream side of an air flow path of a vehicular air conditioning apparatus and constituting a tubular shape, an inner pipe portion constituting a tubular shape, formed at an inner portion of the outer pipe portion, a first inner end constituting one end in an axial direction being integrated to an inner peripheral face of the outer pipe portion, a second inner end constituting other end in the axial direction being arranged on the downstream side of the air flow path of the first inner end, and an outer peripheral face of the second inner end being separated from the inner peripheral face of the outer pipe portion, a side branch type sound suppressing chamber defined by an inner peripheral face of the outer pipe portion and the outer peripheral face of the inner pipe portion, and the outer pipe portion includes an adjusting portion continuous to the upstream side of the air flow path of the first inner end.

It is preferable that the air conditioner duct of the invention includes at least one of (1) through (7) described below.

(1) An inner pipe portion includes an inner side partitioning portion which is a portion between the first inner end and the second inner end, a radial cross-sectional area of an inner peripheral face of the inner side partitioning portion is smaller than a radial cross-sectional area of an inner peripheral face of the first inner end, and a radial cross-section of an inner peripheral face of the adjusting portion is constituted by a constant shape.

(2) A radial cross-sectional area of an inner peripheral face of the second inner end is larger than the radial cross-sectional area of the inner peripheral face of the inner side portioning portion.

(3) The outer pipe portion includes a first outer end disposed on an outer-peripheral side of the first inner end, a second outer end disposed on an outer peripheral side of the second inner end, and an outer side partitioning portion which is a portion between the first outer end and the second outer end, and a radial cross-sectional area of an inner peripheral face of the outer side portioning portion is larger than a radial cross-sectional area of an inner peripheral face of the first outer end.

(4) A radial cross-sectional area of an inner peripheral face of the second outer end is smaller than the radial cross-sectional area of the inner peripheral face of the outer side partitioning portion.

(5) The inner pipe portion includes an erected wall projected from the outer peripheral face of the inner pipe portion to the inner peripheral face of the outer pipe portion, a projected end face of the erected wall and the inner peripheral face of the outer pipe portion are separated, the erected wall is extended in a direction of being intersected with an axis line of the cylinder portion, and a distance in an axial direction between a first erected end constituting one end of the erected wall and the first inner end and a distance in the axial direction between a second erected end constituting other end of the erected wall and the first inner end differ from each other.

(6) A length in the axial direction of the adjusting portion is equal to or larger than 30 mm.

(7) There are provided a first divided member comprising a portion of the outer pipe portion on the downstream side of the air flow path of the adjusting portion, and a second divided member constituted by integrally forming a portion of the outer pipe portion on the upstream side of the air flow path including the adjusting portion and the inner pipe portion, the inner pipe portion of the second divided member is inserted to an inner portion of the first divided member, and the first divided member and the second divided member are fixedly attached to be integrated to each other.

The air conditioner duct of the invention includes the outer pipe portion and the inner pipe portion. The inner pipe portion is formed on the inner peripheral side of the outer pipe portion. Further, one end (first inner end) of the inner pipe portion is integrated to the inner peripheral face of the outer pipe portion. The outer peripheral face of the other end (second inner end) of the inner pipe portion and the inner peripheral face of the outer pipe portion are separated. Therefore, the air conditioner duct of the invention partitions the side branch type noise suppressing chamber (that is, a portion functioning as a side branch type noise suppressor) by the inner peripheral face of the outer pipe portion and the outer peripheral face of the inner pipe portion. The side branch type noise suppressing chamber is extended along the air conditioner duct. Therefore, the air conditioner duct of the invention can reduce noise and is not bulky.

Farther, the outer pipe portion of the air conditioner duct of the invention includes the adjusting portion continuous to the upstream side of the air flow path of the first inner end. In other words, the outer pipe portion of the air conditioner duct of the invention is extended up to the upstream side of the air flow path of the side branch type noise suppressing chamber. By pertinently setting a length of the adjusting portion, a length of the side branch type sound suppressing chamber (that is, a pipe length of the side branch type noise suppressor) can be set to a length in accordance with a frequency of a restraining object sound, and an opening end face can be arranged at a loop of a sound pressure. Therefore, according to the air conditioner duct of the invention, the necessary object sound can sufficiently be reduced.

According to the air conditioner duct of the invention having (1) mentioned above, the radial cross-sectional area of the inner peripheral face of the inner side partitioning portion (the portion between the first inner end and the second inner end of the inner pipe portion) is smaller than the radial cross-sectional area of the inner peripheral face of the first inner end. In other words, according to the air conditioner duct of the invention having (1) mentioned above, at least a portion of the inner side partitioning portion is constituted by a narrowed shape. Therefore, noise transmitted from the vehicular air conditioner apparatus to the air conditioner duct of the invention is attenuated in passing through the inner side partitioning portion. Therefore, according to the air conditioner duct of the invention having (1) mentioned above, noise can further be reduced.

Further, according to the air conditioner duct of the invention having (1) mentioned above, an outer shape of the air conditioner duct can be reduced by bringing at least a portion of the side branch type noise suppressing chamber to the inner peripheral side of the air conditioner duct. Therefore, the air conditioner duct of the invention having (1) mentioned above is not bulky.

Further, according to the air conditioner duct of the invention having (1) mentioned above, the radial cross-section of the inner peripheral face of the adjusting portion is constituted by a constant shape. Therefore, a flow direction of air at an inner portion of the air conditioner duct is rectified to a direction in correspondence with an inner peripheral face of the adjusting portion. Therefore, according to the air conditioner duct of the invention having (1) mentioned above, a flow direction of air flowing to the inner side partitioning portion constituting the narrowed shape can previously be rectified by the adjusting portion, and therefore, a turbulent flow at the inner side partitioning portion can be restrained from being generated. Therefore, according to the air conditioner duct of the invention having (1) mentioned above, a whistling sound can be reduced and a pressure loss can be restrained from being increased.

When the air conditioner duct of the invention has (2) mentioned above, a turbulent flow at an inner portion of the air conditioner duct can further be restrained from being generated. By making the radial cross-sectional area of the inner peripheral face of the second inner end larger than the radial cross-sectional area of the inner peripheral face of the inner side partitioning portion, a length in a radial direction between the inner peripheral face of the outer pipe portion and the inner peripheral face of the second inner end can be reduced, which is for further enabling to restrain a turbulent flow from being generated by further reducing an amount of air flowing in parallel with the opening end face.

According to the air conditioner duct of the invention having (3) mentioned above, by expanding at least a portion of the side branch type noise suppressing chamber to an outer peripheral side of the air conditioner duct, a sectional area of the inner pipe portion can be increased. Therefore, according to the air conditioner duct of the invention having (3) mentioned above, the pressure loss can be restrained from being increased.

When the air conditioner duct of the invention has (4) mentioned above, a turbulent flow at an inner portion of the air conditioner duct can further be restrained from being generated. By making the radial cross-sectional area of the inner peripheral face of the second outer end smaller than the radial cross-sectional area of the inner peripheral face of the outer side partitioning portion, a length in the radial direction between the inner peripheral face of the outer pipe portion and the inner peripheral face of the second inner end can be reduced and a turbulent flow can further be restrained from being generated similar to (2) mentioned above.

According to the air conditioner duct of the invention having (5) mentioned above, a plurality of kinds of the restraining object sound can be reduced.

When the air conditioner duct of the invention has (6), a turbulent flow at the inner side partitioning portion constituting the narrowed shape can further be restrained from being generated, and therefore, a restraining sound can further be reduced, and the pressure loss can further be restrained from being increased. Because by increasing a length in the axial direction of the adjusting portion, a flow of air flowing into the inner side partitioning portion can further firmly be rectified by the adjusting portion.

When the air conditioner duct of the invention has (7), the air conditioner duct can be formed with a high dimensional accuracy, and therefore, the restraining object sound can further be reduced.

According to another aspect of the invention, there is provided a duct for air conditioning constituted by being blow-molded and connected to a downstream side of an air flow path of a vehicular air conditioning apparatus, the duct for air conditioning including an outer cylinder portion constituting a cylinder shape, an inner cylinder portion constituted by a cylinder shape, arranged at an inner portion of the outer cylinder portion, a first inner end constituting one end in an axial direction being integrated to an inner peripheral face of the outer cylinder portion, a second inner end constituting other end in the axial direction being arranged on the downstream side of the air flow path of the first inner end, and an outer peripheral face of the second inner end and the inner peripheral face of the outer cylinder portion being separated from each other, and a side branch type silencer chamber partitioned by the inner peripheral face of the outer cylinder portion and an outer peripheral face of the inner cylinder portion, wherein the inner cylinder portion and an opposed face portion comprising a portion of the outer cylinder portion for covering an outer peripheral side of the inner cylinder portion comprise separately and assembled to integrate, and at least one of the opposed face portion and the inner cylinder portion are integrally formed with a spacer portion projected to other thereof.

It is preferable that the duct for air conditioning of the invention includes at least one of (8) through (11) described below.

(8) The spacer portion is formed at least one of the opposed face portion and the inner cylinder portion and is brought into contact with other thereof.

(9) At least a pair of the spacer portions are formed and the paired spacer portions are arranged symmetrically by interposing an axis line of the opposed face portion.

(10) The spacer portions are formed at the inner cylinder portion.

(11) The spacer portions are formed at the second inner end of the inner cylinder portion.

The air conditioning of the invention is provided with the outer cylinder portion and the inner cylinder portion. The inner cylinder portion is formed on the inner peripheral side of the outer cylinder portion. Further, the one end (the first inner end) of the inner cylinder portion is integrated to the inner peripheral face of the outer cylinder portion. The outer peripheral face of the other end (the second inner end) of the inner cylinder portion and the inner peripheral face of the outer cylinder portion are separated from each other. Therefore, the duct for air conditioning of the invention partitions the side branch type silencer chamber (that is, a portion functioning as the side branch type silencer) by the inner peripheral face of the outer cylinder portion (in details, the inner peripheral face of the opposed face portion) and the outer peripheral face of the inner cylinder portion. The side branch type silencer chamber is extended along the duct for air conditioning. Therefore, the duct for air conditioning of the invention can reduced noise and is not bulky.

Further, at least one of the opposed face portion and the inner cylinder portion is formed with the spacer portion. The spacer portion is projected to the inner peripheral face of other thereof. Therefore, the spacer portion maintains a distance in a diameter direction of the opposed face portion and the inner cylinder portion at a constant or more of a size at least a portion in a peripheral direction of the duct for air conditioning. Therefore, the distance in the diameter direction between the outer peripheral face of the inner cylinder portion and the inner peripheral face of the opposed face portion at the opening end face is difficult to be dispersed. Therefore, the duct for air conditioning of the invention is excellent in a function of reducing restraining object sound.

Further, the duct for air conditioning of the invention is constituted by being blow-molded, further, the spacer portion is integrally molded with at least one of the opposed face portion and the inner cylinder portion. Therefore, the duct for air conditioning of the invention can inexpensively be fabricated.

When the duct for air conditioning of the invention includes the above described (8), the spacer portion is brought into contact with the inner peripheral face of the opposed face portion (or inner cylinder portion), and therefore, the distance in the diameter direction between the outer peripheral face of the inner cylinder portion and the inner peripheral face of the oppose face portion at the opening end face is made to be further difficult to be dispersed. Therefore, the duct for air conditioning of the invention including the above-described (8) is further excellent by the function of reducing the restraining object sound.

When the duct for air conditioning of the invention includes the above-described (9), the inner cylinder portion can be fixed in the diameter direction to the opposed face portion by the spacer portions. Therefore, the distance between the outer peripheral face of the inner cylinder portion and the inner peripheral face of the opposed face portion at the opening end face is made to be further difficult to be dispersed. Therefore, the duct for air conditioning of the invention including the above-described (9) is further excellent by the function of reducing the restraining object sound.

Meanwhile, the spacer portion formed at the inner cylinder portion is projected in the direction of the outer periphery of the inner cylinder portion. The spacer portion formed at the opposed face portion is projected to the direction of the inner periphery of the opposed face portion. In a blow-molding member, a portion on an outer peripheral face side is more excellent than a portion on an inner peripheral face side in a dimensional accuracy. Therefore, a duct for air conditioning formed with a spacer portion at an inner cylinder portion is more excellent than a duct for air conditioning formed with a spacer portion at an opposed face portion in a dimensional accuracy of the spacer portion. According to the duct for air conditioning of the invention excellent in the dimensional accuracy of the spacer portion, the distance in the diameter direction between the outer peripheral face of the inner cylinder portion and the inner peripheral face of the opposed face portion at the opening end face is made to be further difficult to be dispersed. Therefore, the duct for air conditioning of the invention including the above-described (10) is further excellent by the function of reducing the restraining object sound.

When the duct for air conditioning of the invention includes the above-described (11), the spacer portion is formed proximately to the opening end face (or formed at the opening end face), and therefore, the distance in the diameter direction between the outer peripheral face of the inner cylinder portion and the inner peripheral face of the opposed face portion at the opening end face is made to be further difficult to be dispersed. Therefore, the duct for air conditioning of the invention including the above-described (11) is further excellent by the function of reducing the restraining object sound.

### BRIEF DESCRIPTION OF THE DRAWINGS

FIG. 1 is a perspective view schematically showing an air conditioner duct of example 1.

FIG. 2 is a view enlarging an essential portion schematically showing a section in an axial direction of the air conditioner duct of example 1.

FIG. 3 is an explanatory view schematically showing an inner peripheral face of the air conditioner duct of example 1.

FIG. 4 is an explanatory view schematically showing a behavior of fabricating the air conditioner duct of example 1.

FIG. 5 is an explanatory view schematically showing a behavior of fabricating the air conditioner duct of example 1.

FIG. 6 is a view enlarging an essential portion schematically showing a section in an axial direction of an air conditioner duct of example 2.

FIG. 7 is a perspective view enlarging an essential portion schematically showing an inner pipe portion of an air conditioner duct of example 3.

FIG. 8 is a sectional view schematically showing a behavior of cutting the air conditioner duct of example 3 at an A-A position in FIG. 7.

FIG. 9 is a sectional view schematically showing a behavior of cutting the air conditioner duct of example 3 at a B-B position in FIG. 7.

FIG. 10 is a perspective view enlarging an essential portion schematically showing an inner pipe portion of an air conditioner duct of example 4.

FIG. 11 is a sectional view schematically showing a behavior of cutting the air conditioner duct of example 4 at an A-A position in FIG. 10.

FIG. 12 is a view enlarging an essential portion schematically showing a section in an axial direction of an air conditioner duct of comparative example 1.

FIG. 13 is a view enlarging an essential portion schematically showing a section in an axial direction of an air conditioner duct of comparative example 2.

FIG. 14 is a graph showing a result of a noise measuring test.

FIG. 15 is a perspective view schematically showing an air conditioner duct of example 5.

FIG. 16 is a view enlarging an essential portion schematically showing a section in an axial direction of the air conditioner duct of example 5.

FIG. 17 is an explanatory view schematically showing a behavior of fabricating the air conditioner duct of example 5.

FIG. 18 is an explanatory view schematically showing the behavior of fabricating the air conditioner duct of example 5.

FIG. 19 is a view enlarging an essential portion schematically showing a section in an axial direction of an air conditioner duct of example 6.

FIG. 20 is a view enlarging an essential portion schematically showing a section in an axial direction of an air conditioner duct of example 7.

FIG. 21 is a perspective view schematically showing a duct for air conditioning of example 8.

FIG. 22 is a view enlarging an essential portion schematically showing a section in an axial direction of the duct for air conditioning of example 8.

FIG. 23 is a sectional view schematically showing a section in a diameter direction of the duct for air conditioning of example 8.

FIG. 24 is an explanatory view schematically showing a behavior of fabricating the duct for air conditioning of example 8.

FIG. 25 is an explanatory view schematically showing the behavior of fabricating the duct for air conditioning of example 8.

FIG. 26 is a perspective view schematically showing a duct for air conditioning of example 9.

FIG. 27 is a view enlarging essential portions schematically showing a section in an axial direction of the duct for air conditioning of example 9.

FIG. 28 is an explanatory view schematically showing a behavior of fabricating the duct for air conditioning of example 9.

FIG. 29 is an explanatory view schematically showing the behavior of fabricating the duct for air conditioning of example 9.

FIG. 30 is an explanatory view for explaining a slit resonator of a background art.

FIG. 31 is an explanatory view for explaining the slit resonator of the background art.

FIG. 32 is a view enlarging an essential portion schematically showing a section in an axial direction of a suction duct of the background art.

### DETAILED DESCRIPTION OF THE PREFERRED EMBODIMENTS

The outer pipe portion of the air conditioner duct of the invention may be constituted by a tubular shape and can be constituted by shapes of a circular cylinder shape, a square cylinder shape and the like. Also the inner pipe portion may be constituted by a tubular shape and can be formed by various shapes of the circular cylinder shape, the square cylinder shape and the like. An axis line of the outer pipe portion and an axis line of the inner pipe portion may coincide with each other, or may not coincide with each other. That is, a gap between the inner peripheral face of the outer pipe portion and the outer peripheral face of the inner pipe portion may be constant in a peripheral direction, or may not be constant. Further, in order to restrain a turbulent flow from being generated at a portion of the outer pipe portion on the downstream side of the air flow path of the inner pipe portion (that is, downstream portion), it is preferable that the axis line of the outer pipe portion and the axis line of the inner pipe portion coincide with each other. Wall thicknesses of the outer pipe portion and the inner pipe portion may be constant, or may not be constant.

Although a shape of the adjusting portion is not particularly limited, in order to restrain a turbulent flow from being generated at the inner side partitioning portion, it is preferable that the shape is a shape by which the radial cross-section of the inner peripheral face becomes constant. In the following, a radial cross-section of the inner peripheral face of each portion of the air conditioner duct of the invention is abbreviated simply as the radial cross-section. Also the radial cross-sectional area of the inner peripheral face of each portion of the air conditioner duct of the invention is abbreviated simply as the radial cross-sectional area. Although it is preferable that an axis line of the adjusting portion is constituted by a curved shape, it is preferable that the axis line is constituted by a linear shape. When the axis line of the adjusting portion is constituted by the linear shape, a turbulent flow can further be restrained from being generated at the inner side partitioning portion. Further, an axis line of the downstream portion may be constituted by a linear shape or may be constituted by a curved shape.

Although an axis line of the inner pipe portion may be constituted by a curved shape, it is preferable that the axis line is constituted by a linear shape. When the axis line of the inner pipe portion is constituted by the linear shape, the pressure loss can further firmly be restrained from being increased.

According to the air conditioner duct of the invention, the first divided member may be constituted only by a portion of the outer pipe portion (a portion on the downstream side of the air flow path of the adjusting portion) and may include other portion (for example, a fixing end for attaching the air conditioner duct to other member or the like). Similarly, the second divided member may be constituted only by a portion of the outer pipe portion (a portion on the upstream side of the air flow path including the adjusting portion) and the inner pipe portion, or may include other portion.

The first divided member and the second divided member may be fixedly attached to be integrated with each other by a known method. For example, the first divided member and the second divided member may be fixedly attached to be integrated to each other by a method of adhering, welding, fastening or the like. Or, the first divided member and the second divided member may respectively be provided with fitting portions and the first divided member and the second divided member may be fixedly attached to be integrated to each other by being fitted to each other.

### EXAMPLES

An air conditioner duct of the invention will be explained in reference to the drawings as follows.

### Example 1

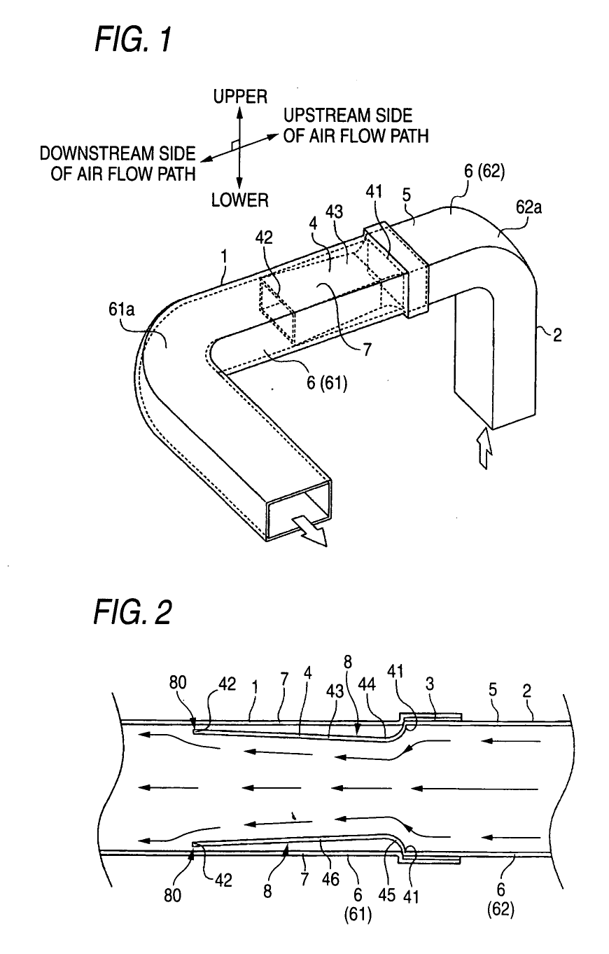

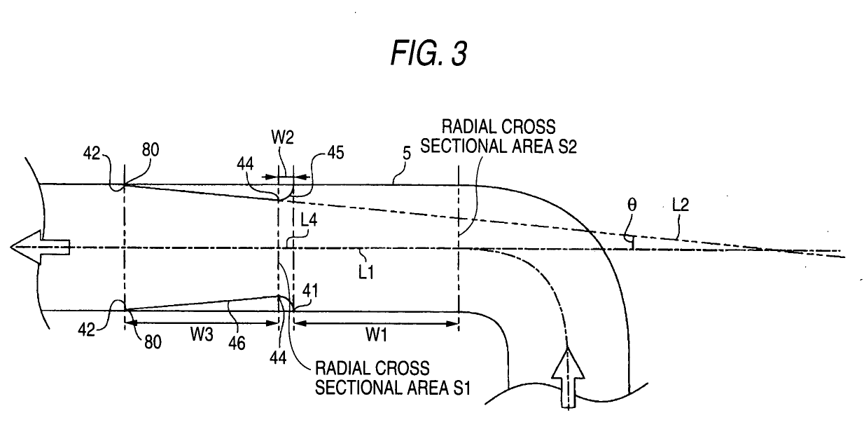

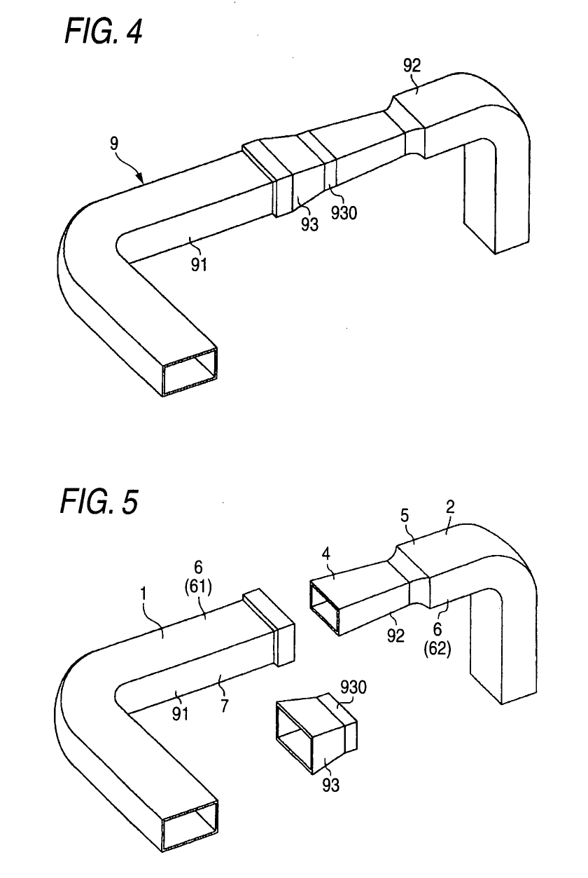

An air conditioner duct of example 1 has (1), (2), (6), (7) mentioned above. FIG. 1 shows a perspective view schematically showing the air conditioner duct of example 1. FIG. 2 shows a view enlarging an essential portion schematically showing a section in an axial direction of the air conditioner duct of example 1. FIG. 3 shows an explanatory view schematically showing an inner peripheral face of the air conditioner duct of example 1. FIG. 4 and FIG. 5 show explanatory views schematically showing a behavior of fabricating the air conditioner duct of example 1.

The air conditioner duct of example 1 is connected to a downstream side of an air flow path of a vehicular air conditioning apparatus (not illustrated). As shown by FIG. 1, the air conditioner duct of example 1 is constituted by the first divided member 1 substantially in a square cylinder shape, and the second divided member 2 substantially in a square cylinder shape. The first divided member 1 constitutes a portion on a downstream side of the air flow path of the air conditioner duct. The second divided member 2 constitutes a portion on an upstream side of the air flow path of the air conditioner duct.

An end portion on an upstream side of the air flow path of the first divided member 1 is slightly enlarged in a diameter thereof. A diameter of a portion on a downstream side of the air flow path of the second divided member 2 is smaller than a portion on an upstream side of the air flow path of the second divided member 2 and that of a portion on the upstream side of the air flow path of the first divided member 1. The portion on the downstream side of the air flow path of the second divided member 2 is inserted to the portion on the upstream side of the air flow path of the first divided member 1. As shown by FIG. 2, an inner peripheral face of an end portion on the upstream side of the air flow path of the first divided member 1 is laminated with an adhering member layer 3. The first divided member 1 and the second divided member 2 are adhered by the adhering member layer 3 to be integrated.

The inner pipe portion 4 of the air conditioner duct of example 1 is constituted by the portion on the downstream side of the air flow path of the second divided member (that is, a portion of the second divided member 2 inserted to the portion on the upstream side of the air flow path of the first divided member 1). The adjusting portion 5 is constituted by the portion of the second divided member 2 continuous to the upstream side of the air flow path of the inner pipe portion 4. The outer pipe portion 6 is constituted by the portion on the upstream side of the air flow path of the second divided member 2 (a portion of the second divided member 2 which is not inserted to the inner portion of the first divided member 1, that is, the adjusting portion 5 and a portion thereof on the upstream side of the air flow path continuous to the adjusting portion 5) and the first divided member 1. In other words, the first divided member 1 is constituted by a portion of the outer pipe portion 6 on the downstream side of the air flow path of the adjusting portion 5. The second divided member 2 is integrally formed with a portion of the outer pipe portion on the upstream side of the air flow path including the adjusting portion 5 and the inner pipe portion 4.

A portion of the outer pipe portion 6 constituted by the first divided member 1 is referred to as a first outer pipe portion 61, and a portion of the outer pipe portion 6 constituted by the second divided member 2 is referred to as a second outer pipe portion 62. A portion of the first outer pipe portion 61 covering the outer peripheral side of the inner pipe portion 4 is referred to as an opposed portion 7.

A radial cross-sectional area of the outer pipe portion 61 is substantially constant. The opposed portion 7 is constituted by a straight cylinder shape. That is, an axis line of the opposed portion 7 is constituted by a linear shape. As shown by FIG. 1, the first outer pipe portion 61 includes a first bent portion 61a in a bent cylinder shape substantially at a center portion in the axial direction. The axis line of the first bent portion 61a is constituted by an arc shape.

A radial cross-sectional area of the second outer pipe portion 62 is substantially constant. The adjusting portion 5 is constituted by a straight cylinder shape. That is, an axis line of the adjusting portion 5 is constituted by a linear shape. As shown by FIG. 1, the second outer pipe portion 62 includes a second bent portion 62a in a bent cylinder shape at a portion thereof continuous to the upstream side of the air flow path of the adjusting portion 5. An axis line of the second bent portion is constituted by an arc shape.

The inner pipe portion 4 includes a first inner end 41 and a second inner end 42 and an inner side partitioning portion 43. The first inner end 41 is continuous to the downstream side of the air flow path of the adjusting portion 5 and is integrated to the inner peripheral face of the outer pipe portion 6. The second inner end 42 is an end portion on the downstream side of the air flow path of the inner pipe portion 4. The outer peripheral face of the second inner end 42 and the inner peripheral face of the first outer pipe portion 61 (inner peripheral face of the opposed portion 7) are separated and a gap is formed therebetween. The gap constitutes an opening end face 80 of the side branch type noise suppressing chamber 8 mentioned later.

The inner side partitioning portion 43 is a portion between the first inner end 41 and the second inner end 42 for connecting the first inner end 41 and the second inner 42. A portion of the inner side partitioning portion 43 proximate to the adjusting portion 5 is provided with the least radial cross-sectional area in the inner pipe portion 4. The portion is referred to as a minimum diameter portion 44. The radial cross-sectional area of the inner pipe portion 4 is rapidly reduced from the first inner end 41 to the minimum diameter portion 44. Further, the radial cross-sectional area of the inner pipe portion 4 is gradually increased from the minimum diameter portion 44 to the second inner end 42. As described above, the outer peripheral face of the second inner end 42 and the inner peripheral face of the first outer pipe portion 61 are separated. Therefore, the radial cross-sectional area of the inner side partitioning portion 43 is smaller than the radial cross-sectional area of the first inner end 41.

A length W1 in the axial direction of the adjusting portion 5 (shown in FIG. 2) is 94 mm. A sectional area S2 in the radial direction of the adjusting portion 5 is 4976 mm². A sectional area S1 in the radial direction of the minimum diameter portion 44 is 2372 mm². A line segment cutting a portion of the inner pipe portion 4 from the first inner end 1 to the minimum diameter portion 44 (hereinafter, referred to as a narrowing rapid change portion 45) in the axial direction constitutes a circular arc shape. A radius of the circular arc is 10 mm. Also a length W2 in the axial direction of the narrowing rapid change portion 45 is 10 mm. A length W3 in the axial direction of a portion of the inner pipe portion 4 from the minimum diameter portion 44 to the second inner end 42 (hereinafter, referred to as a return portion 46) is 85 mm. A distance between the outer peripheral face of the second inner end 42 and the inner peripheral face of the opposed portion 7 (a length in a radial direction of the opening end face 80) is 85 mm. Further, an angle θ made by an axis line L1 of the adjusting portion 5 and a linear line L2 is 6.7°. The linear line L2 is a linear line disposed on a plane the same as that of the center axis L1 of the inner pipe portion 4, passing the second inner end 42 and brought into contact with the return portion 46.

As shown by FIG. 2, a space is formed between the outer peripheral face of the inner pipe portion 4 and the inner peripheral face of the opposed portion 7. The space communicates with the inner peripheral side of the inner pipe portion 4 by way of a gap between the outer peripheral face of the second inner end 42 and the inner peripheral face of the outer pipe portion 6 (that is, the opening end face 80). Therefore, according to the air conditioner duct of example 1, the side branch type noise suppressing chamber 8 is defined by the inner pipe portion 4 and the opposed portion 7. Therefore, the air conditioner duct of example 1 can reduce noise by the side branch type noise suppressing chamber 8. Further, the side branch type noise suppressing chamber 8 is extended along the air conditioner duct and brought to the inner peripheral side of the air conditioner duct, and therefore, the air conditioner duct of example 1 is not bulky regardless of having the side branch type noise suppressing chamber 8.

Meanwhile, a resonance frequency fo of the side branch type noise suppressor can be calculated based on the following equation 1. The restraining object sound can be reduced when fo is made to be coincident with or proximate to a frequency of the restraining object sound.

fo=c/4(1+Δl) (equation 1)

Further, notation c designates a sound velocity, notation l designates a pipe length of the side branch type noise suppressor, and notation Δl designates a corrected length of the side branch depending on an opening end area and an opening peripheral boundary.

According to the air conditioner duct of example 1, the gap between the second inner end 42 of the inner pipe portion 4 and inner peripheral face of the opposed portion 7 corresponds to the opening end face of the side branch type noise suppressor. A length in the axial direction of the side branch type noise suppressing chamber 8 (that is, a length in the axial direction of the inner pipe portion 4) corresponds to the pipe length 1 of the side branch type noise suppressor. The pipe length l of the air conditioner duct of example 1 corresponds to W2≦l≦W2+W3 and is 85 through 95 mm. Therefore, the restraining object sound of the air conditioner duct of example 1 is noise having a frequency at a vicinity of 900 through 1000 Hz. Further, a frequency of noise generated at the vehicular air conditioner apparatus is mainly at a vicinity of 1000 Hz. Therefore, according to the air conditioner duct of example 1, the restraining object sound, that is, noise generated at the vehicular air conditioning apparatus can firmly be reduced.

Further, the radial cross-sectional area of the inner side partitioning portion 43 is smaller than the radial cross-sectional area of the first inner end 41. In other words, the inner side partitioning portion 43 of the air conditioner duct of example 1 is provided with the minimum diameter portion 44 to constitute a narrowed shape. Therefore, noise transmitted from the vehicular air conditioner apparatus to the air conditioner duct of example 1 is attenuated in passing the inner side partitioning portion 43. Also thereby, the air conditioner duct of example 1 can reduce noise.

Further, a radial cross-section of the adjusting portion 5 of the air conditioner duct of example 1 is constituted by a constant shape, and therefore, as shown by FIG. 2, a flow direction of air blown out by the vehicular air conditioner apparatus is rectified to a constant direction in correspondence with the inner peripheral face of the adjusting portion 5. Therefore, the flow direction of air flowing to the inner side partitioning portion 43 is previously rectified by the adjusting portion 5, and therefore, a turbulent flow is difficult to be generated at the inner side partitioning portion 43. Therefore, according to the air conditioner duct of example 1, an amount of air flowing in parallel with the opening end face 80 is reduced, and therefore, a whistling sound is restrained from being generated. Further, the pressure loss can be restrained from being increased by restraining the turbulent flow at the inner side partitioning portion 43 from being generated.

According to the air conditioner duct of example 1, by pertinently setting the length of the adjusting portion 5, the length in the axial direction of the side branch type noise suppressing chamber 8 is set to the length in accordance with the frequency of the restraining object sound and the opening end face 80 can be arranged at a loop of a sound pressure. Therefore, according to the air conditioner duct of example 1, the restraining object sound can sufficiently be reduced.

According to the air conditioner duct of example 1, the radial cross-sectional area of the inner peripheral face of the second inner end 42 is larger than the radial cross-sectional area of the inner peripheral face of the inner side partitioning portion 43. Therefore, the length in the radial direction between the inner peripheral face of the outer pipe portion 6 and the inner peripheral face of the second inner end 42 can be reduced. Therefore, according to the air conditioner duct of example 1, an amount of air flowing in parallel with the opening end face 80 is further reduced and the turbulent flow is further restrained from being generated.

A length in the axial direction of the adjusting portion 5 of the air conditioner duct of example 1 is 94 mm and is sufficiently long. Therefore, according to the air conditioner duct of example 1, the turbulent flow can further be restrained from being generated at the inner side partitioning portion 43. Therefore, the air conditioner duct of example 1 can further reduce the whistling sound and can further restrain the pressure loss from being increased.

According to the air conditioner duct of example 1, the inner peripheral face of the portion of the inner side partitioning portion 43 from the first inner end 41 to the minimum diameter portion 44 (that is, the narrowed rapid change portion 45) and the inner peripheral face portion of the inner side partitioning portion 43 from the minimum diameter portion 44 to the second inner end 42 (that is, the return portion 46) are smoothly made to be continuous. Therefore, air passing through the adjusting portion 5 smoothly flows to the return portion 46 by way of the narrowed rapid change portion 45. Therefore, according to the air conditioner duct of example 1, the turbulent flow can further be restrained from being generated at the inner side partitioning portion 43.

Further, although it is preferable to reduce the sectional area S1 in the radial direction of the minimum diameter portion 44 in order to reduce noise considerably, according to the air conditioner duct of the invention, noise is reduced also by the side branch type noise suppressing chamber 8. Therefore, according to the air conditioner duct of the invention, noise can sufficiently be reduced even when the sectional area S1 in the radial direction of the minimum diameter portion 44 is comparatively large (for example, the sectional area S1 in the radial direction of the minimum diameter portion 44 exceeds about 50% of the sectional area S2 in the radial direction of the adjusting portion 5).

According to the air conditioner duct of the invention, it is preferable to increase the sectional area S1 in the radial direction of the minimum diameter portion 44 in order to restrain the pressure loss from being increased. According to the air conditioner duct of the invention, when the sectional area S1 in the radial direction of the minimum diameter portion 44 is made to be equal to or larger than 9/20 of the sectional area S2 in the radial direction of the adjusting portion 5, the radial cross-sectional area of the inner side partitioning portion 43 does not become excessively small. Therefore, the pressure loss can further be restrained from being increased. For reference, the sectional area S1 in the radial direction of the minimum diameter portion 44 of the air conditioner duct of example 1 is 2372 mm², and the sectional area S2 in the radial direction of the adjusting portion 5 is 4976 mm². Therefore, S1 of the air conditioner duct of example 1 is equal to or larger than 9/20 of S2. Therefore, the air conditioner duct of example 1 can further restrain the pressure loss from being increased.

Meanwhile, when the inner side partitioning portion 43 is constituted by a narrowed shape, in order to considerably reduce noise, it is preferable to prolong the length in the axial direction of the inner side partitioning portion 43 and in order to restrain the pressure loss from being increased, it is preferable to shorten the length in the axial direction of the inner side partitioning portion 43. The inner side partitioning portion 43 of the air conditioner duct of example 1 is provided with the return portion 46, and therefore, the length in the axial direction of the portion of the inner side partitioning portion 43 minimizing the radial cross-sectional area (minimum diameter portion 44) can be shortened. Therefore, according to the air conditioner duct of example 1, the pressure loss can further be restrained from being increased.

Further, in order to considerably reduce noise, it is preferable to prolong the length W2 in the axial direction of the narrowed rapid change portion 45 and in order to restrain the pressure loss from being increased, it is preferable to shorten the length W2 in the axial direction of the narrowed rapid change portion 45. According to the air conditioner duct of the invention, so far as the length W2 in the axial direction of the narrowed rapid change portion 45 is equal to or larger than 10 mm, noise due to the vehicular air conditioner apparatus can be reduced. Further, when the length W2 in the axial direction of the narrowed rapid change portion 45 is made to be equal to or smaller than ¼ of a radius (hereinafter, referred to as r2) of a circle an area of which is equal to S2, the length W2 in the axial direction of the narrowed rapid change portion 45 is sufficiently shortened, and therefore, the pressure loss can further be restrained from being increased. That is, according to the air conditioner duct of the invention, it is preferable that the length W2 in the axial direction of the narrowed rapid change portion 45 is equal to or larger than 10 mm. Further, it is preferable that the length W2 in the axial direction of the narrowed rapid change portion 45 is equal to or smaller than ¼ of the radius of the circle the area of which is equal to S2. For reference, the length W2 in the axial direction of the narrowed rapid change portion 45 of the air conditioner duct of example 1 is 10 mm, and the radius r2 of the circle of the area of which is equal to S2 is about 40 mm. Therefore, according to the air conditioner duct of example 1, the length W2 in the axial direction of the narrowed rapid change portion 45 is equal to or smaller than ¼ of the radius r2 of the circle the area of which is equal to S2.

Further, in order to reduce the pressure loss from being increased, it is preferable to gradually change the radial cross-sectional area of the return portion 46. When the angle θ made by L1 and L2 mentioned above is equal to or smaller than 5°, the radial cross-sectional area of the return portion 46 is gradually changed, and therefore, the pressure loss can further be restrained from being increased.

A method of fabricating a duct for the air conditioner of example 1 will be explained as follows.

### (Middle Molding Step)

First, a parison (not illustrated) comprising PE, PP or the like is prepared. The parison is put into a blow molding die, not illustrated, and a middle mold member 9 shown in FIG. 4 is blow-molded. The middle mold member 9 is constituted by integrally molding a first divided member scheduled portion 91, a second divided scheduled portion 92, and a connecting portion 93. The first divided member scheduled portion 91 includes a portion of the outer pipe portion 6 on the downstream side of the air flow path of the adjusting portion 5. The second divided member scheduled portion 92 includes a portion of the outer pipe portion 6 on the upstream side of the air flow path including the adjusting portion 5, and the inner pipe portion 4.

One end of the connecting portion 93 is integrated to the end portion on the downstream side of the air flow path of the first divided member scheduled portion 91. Other end of the connecting portion 93 is integrated with the end portion on the upstream side of the air flow path of the second divided member scheduled portion 92. A radial cross-sectional area is larger at a portion of the connecting portion 93 on the side of the first divided member scheduled portion 91 than at a portion thereof on the side of the second divided member scheduled portion 92. The radial cross-sectional area is constant at a portion of the connecting portion 93 on the side of the second divided member scheduled portion 92 (referred to as a preparatory portion 930).

### (Removing Step)

By cutting the middle mold member 9 provided by the middle molding step to remove at least a portion of the connecting portion 93 from the middle mold member 9, the first divided member 1 including the first divided member scheduled portion 91 and the second divided member 2 including the second divided member scheduled portion 92 are provided (FIG. 5). Further, in cutting the middle mold member 9, a cutting position is positioned by touching a jig, not illustrated, at the middle mold member 9.

### (Integrating Step)

The adhering member layer 3 is laminated on the inner peripheral face of the end portion on the upstream side of the air flow path of the first divided member 1 provided by the removing step. Further, the inner pipe portion 4 of the second divided member 2 is inserted to an inner portion of the first divided member 1 from the end portion on the upstream side of the air flow path of the first divided member 1 to integrate the first divided member 1 and the second divided member 2. The adhering member layer 3 laminated to the end portion on the downstream side of the air flow path of the first divided member 1 is pasted to the outer peripheral face of the adjusting portion 5. Therefore, the first divided member 1 and the second divided member 2 are adhered by the adhering member layer 3 to be integrated.

The air conditioner duct of example 1 is provided by the middle molding step through the integrating step.

According to the method of fabricating the air conditioner duct of example 1, the first divided member 1 having the opposed portion 7 and the second divided member 2 having the inner pipe portion 4 separate from the first divided member 1 are fixedly attached to be integrated. Therefore, according to the method of fabricating the air conditioner duct of example 1, the inner pipe portion 4 and the opposed portion 7 can accurately be molded. Therefore, according to the method of fabricating the air conditioner duct of example 1, the air conditioner duct capable of reducing the restraining object sound can be fabricated.

Further, by integrally molding the first divided member scheduled portion 91 and the second divided member scheduled portion 92 as the middle mold member 9, the first divided member scheduled portion 91 mainly constituting the first divided member 1 and the second divided scheduled portion 92 mainly constituting the second divided member 2 can be molded by the same mold die (blow die). Therefore, according to the method of fabricating the air conditioner duct of example 1, cost required for the mold die can be reduced and the air conditioner duct can inexpensively be fabricated.

Further, the radial cross-sectional area of the preparatory portion 930 is constant, and therefore, when a length of a portion of the preparatory portion 930 remained for the second divided member 2 is pertinently changed, the length of the inner pipe portion 4 and the length of the side branch type noise suppressing chamber 8 can pertinently be changed. Therefore, according to the method of fabricating the air conditioner duct of example 1, a plurality of kinds of ducts for the air conditioner having different restraining object sounds can be molded by the same mold die.

### Example 2

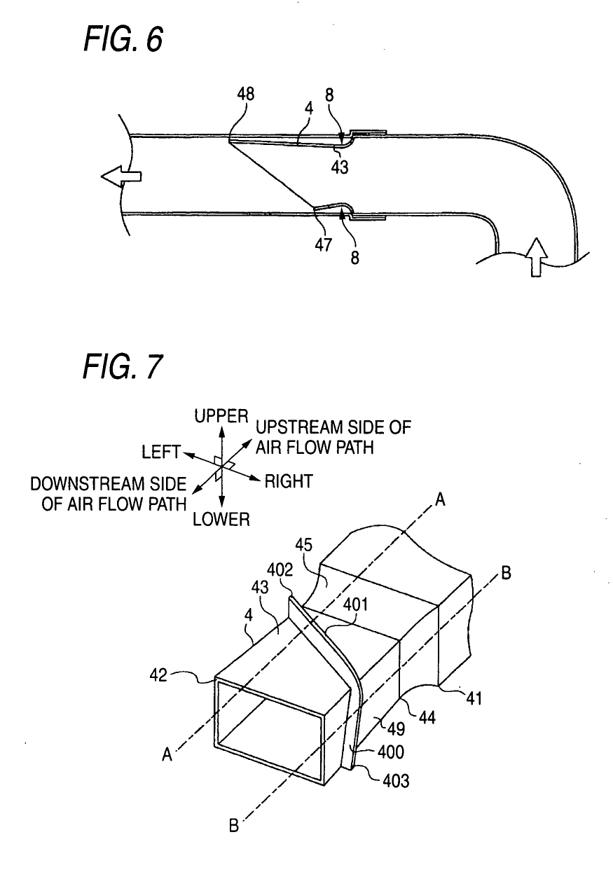

An air duct for an air conditioner of example 2 is provided with (1), (2), (6), (7) mentioned above. The air conditioner duct of example 2 is the same as the air conditioner duct of example 1 except a shape of an inner pipe portion thereof. FIG. 6 shows a view enlarging an essential portion schematically showing a section in an axial direction of the air conditioner duct of example 2.

As shown by FIG. 6, the length in the axial direction of the inner pipe portion 4 of the air conditioner duct of example 2 differs in a peripheral direction. The length in the axial direction of a portion of the inner pipe portion 4 minimizing the length in the axial direction (short axis portion 47) is 28 mm. The length in the axial direction of a portion of the inner pipe portion 4 maximizing the length in the axial direction (long axis portion 48) is 85 mm. The length in the axial direction is gradually changed at a portion between the short axis portion 47 and the long axis portion 48.

Therefore, the side branch type noise suppressing chamber 8 of the air conditioner duct of example 2 is provided with a plurality of kinds of the lengths 1 of the side branch type noise suppressor in equation 1. Therefore, according to the air conditioner duct of example 2, a plurality of kinds of noise having different frequencies can be reduced. In other words, according to the air conditioner duct of example 2, a plurality of kinds of restraining object sound can be reduced.

Further, the inner side partitioning portion 43 of the air conditioner duct of example 2 is constituted by a narrowed shape similar to that of the inner side partitioning portion of the air conditioner duct of example 1. The air conditioner duct of example 2 can reduce noise also thereby.

### Example 3

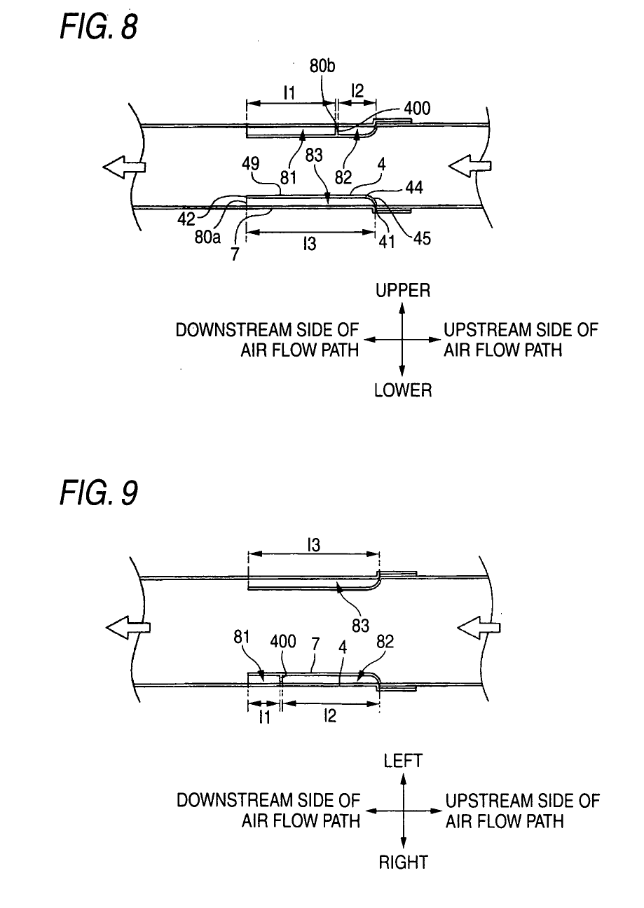

An air conditioner duct of example 3 is provided with (1), (5) through (7) mentioned above. The air conditioner duct of example 3 is the same as the air conditioner duct of example 1 except a shape of an inner pipe portion. FIG. 7 shows a perspective view enlarging an essential portion schematically showing an inner pipe portion of the air conditioner duct of example 3. FIG. 8 shows a sectional view schematically showing a behavior of cutting the air conditioner duct of example 3 at an A-A position in FIG. 7. FIG. 9 shows a sectional view schematically showing a behavior of cutting the air conditioner duct of example 3 at a B-B position of FIG. 7.

The inner pipe portion (inner side partitioning portion 43) includes the narrowed rapid change portion 45 the same as that of the inner pipe portion 4 of the air conditioner duct of example 1. A radial cross-sectional area of a portion of the inner pipe portion 4 on a side of the second inner end 42 of the narrowed rapid change portion 45 and a radial cross-sectional area of the second inner end 42 are the same as a radial cross-sectional area of the minimum diameter portion 44. That is, a portion of the inner pipe portion 4 on a side of the second inner end 42 of the narrowed rapid change portion 45 (hereinafter, referred to as small diameter portion 49) constitutes a straight cylinder shape. A distance between the outer peripheral face of the second inner end 42 and the inner peripheral face of the opposed portion 7 is 5 mm.

Further, the inner pipe portion 4 of the air conditioner duct of example 3 includes an erected wall 400. The erected wall 400 is projected from an outer peripheral face of the small diameter portion 49 to the inner peripheral face of the opposed portion 7. A projected end face 401 of the erected wall 400 and the inner peripheral face of the opposed portion 7 are separated by 5 mm. As shown by FIG. 7, the erected wall 400 is extended over to an upper face and a right side face of the small diameter portion 49). A distance in the axial direction between a first erected end 402 constituting one end of the erected wall 400 and the second inner end 42 is 85 mm. A distance in the axial direction between a second erected end 403 constituting other end of the erected wall 400 and the second inner end is 28 mm. A portion of the erected wall 400 between the first inner end 402 and the second inner end 403 are smoothly continuous to the first inner end 402 and the second inner end 403. Therefore, a distance in the erected wall 400 and the first inner end 41 are gradually changed in a peripheral direction of the inner pipe portion 4.

According to the air conditioner duct of example 3, the side branch type noise suppressing chamber 8 (that is, a space between the outer peripheral face of the inner side partitioning portion 43 and the inner peripheral face of the opposed portion 7) is defined by the erected wall 400. Therefore, as shown by FIG. 8 and FIG. 9, the air conditioner duct of example 3 includes two of the side branch type noise suppressing chamber 8 (first side branch type noise suppressing chamber 81, second side branch type noise suppressing chamber 82) defined by the erected wall 400. The first side branch type noise suppressing chamber 81 is formed on a downstream side of an air flow path of the second side branch type noise suppressing chamber 82. Further, since the erected wall 400 is not provided at a lower face and a left face of the small diameter portion 49, the air conditioner duct of example 3 includes the side branch type noise suppressing chamber 8 which is not defined by the erected wall 400 (third side branch type noise suppressing chamber 83). According to the air conditioner duct of example 3, a gap between the outer peripheral face of the second inner end 42 and the inner peripheral face of the opposed portion 7 constitutes an opening end face 80a of the first side branch type noise suppressing chamber 81 and the third branch type noise suppressing chamber 83, and a gap between the projected end face 401 of the erected wall 400 and the inner peripheral face of the opposed portion 7 constitutes the opening end face 85b of the second side branch type noise suppressing chamber 82.

According to the air conditioner duct of example 3, noise is reduced by the first side branch type noise suppressing chamber 81, the second side branch type noise suppressing chamber 82, and the third side branch type noise suppressing chamber 83. Lengths in the axial direction 11 through 13 of the first side branch type noise suppressing chamber 81 through the side branch type noise suppressing chamber 83 differ from each other, and therefore, the three side branch type noise suppressing chambers 81 through 83 respectively reduce noises having different frequencies. Further, the opening end 80a of the first side branch type noise suppressing chamber 81 and the third side branch type noise suppressing chamber 83, and the opening end face 80b of the second side branch type noise suppressing chamber 82 are formed at different positions. Therefore, the three side branch type noise suppressing chambers 81 through 83 can arrange the opening end faces 80a, and 80b in correspondence with loops of sound pressures in accordance with the respective restraining object sounds. Therefore, the air conditioner duct of example 3 can reduce kinds of the restraining object sounds more than those of the air conditioner duct of example 2.

Further, the inner pipe portion 4 of the air conditioner duct of example 3 constitutes a narrowed shape similar to that of the inner pipe portion of the air conditioner duct of example 1. The air conditioner duct of example 3 can reduce noise also thereby.

Farther, the return portion 46 similar to that of the air conditioner duct of example 1 may be provided at the inner pipe portion 4 of the air conditioner duct of example 3. Further, the erected wall 400 may be extended to an entire periphery of the inner pipe portion 4.

### Example 4

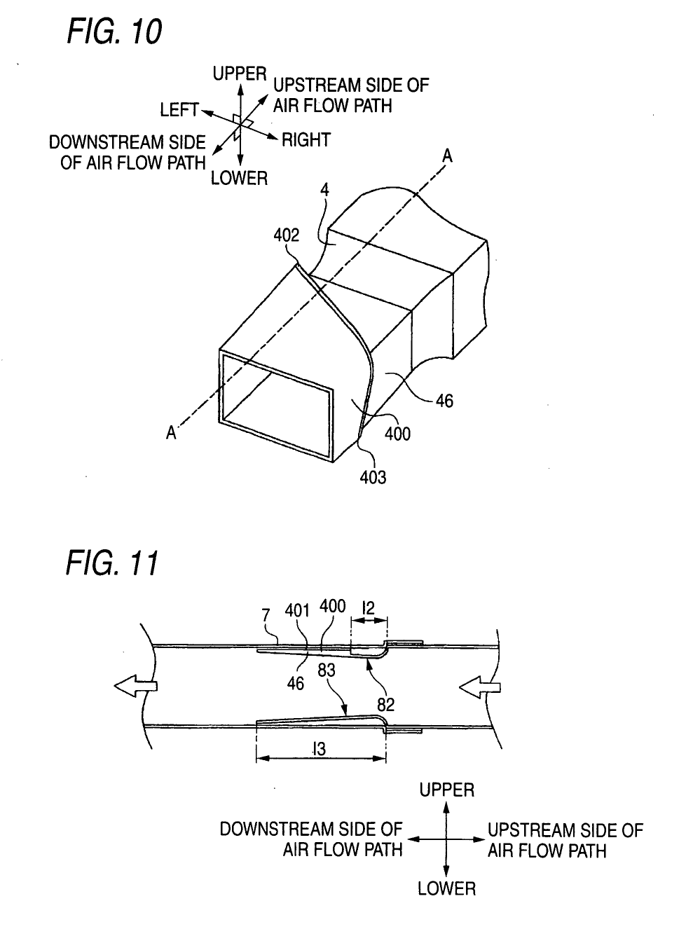

An air conditioner duct of example 4 is provided with (1) through (2), (5) through (7) mentioned above. The air conditioner duct of example 4 is the same as the air conditioner duct of example 1 except a shape of an inner pipe portion. FIG. 10 shows a perspective view enlarging an essential portion schematically showing the inner pipe portion of the air conditioner duct of example 4. FIG. 11 shows a sectional view schematically showing a behavior of cutting the air conditioner duct of example 4 at an A-A position in FIG. 10.

The air conditioner duct of example 4 is provided with the erected wall 400 at the air conditioner duct of example 1. The erected wall 400 of the air conditioner duct of example 4 is projected from the outer peripheral face of the return portion 46 to the inner peripheral face of the opposed portion 7. The projected end face 401 of the erected wall 400 and the inner peripheral face of the opposed portion 7 are separated by 5 mm. Further, the erected wall 400 is extended over the upper face and right side face of the return portion 46. The distance between the erected wall 400 and the first inner end 41 differs in the peripheral direction. A distance in the axial direction between the first erected end 402 constituting one end of the erected wall 400 and the second inner end 42 is 85 mm. The distance in the axial direction between the second erected end 403 constituting other end of the erected wall 400 and the second inner end 42 is 28 mm.

Further, as shown by FIG. 10, the erected wall 400 of the air conditioner duct of example 4 is integrated with the second inner end 42. Therefore, the air conditioner duct of example 4 is not provided with the first side branch type noise suppressing chamber 81 of the air conditioner duct of example 3 but is provided with only the second side branch type noise suppressing chamber 82 and the third side branch type noise suppressing chamber 83.

Although the air conditioner duct of example 4 is provided with only the second side branch type noise suppressing chamber 82 and the third side branch type noise suppressing chamber 83 and is not provided with the first side branch type noise suppressing chamber 81, a length 12 in the axial direction of the second side branch type noise suppressing chamber 82 and a length 13 in the axial direction of the third side branch type noise suppressing chamber 83 differ from each other, and the opening end face 80b of the second side branch type noise suppressing chamber 82 and the opening end face 80a of the third side branch type noise suppressing chamber 83 are formed at positions different from each other. Therefore, the air conditioner duct of example 4 can reduce more kinds of restraining object sounds than those of the air conditioner duct of example 2.

Further, the inner side partitioning portion 43 of the air conditioner duct of example 4 constitutes a narrowed shape similar to the inner side partitioning portion of the air conditioner duct of example 1. The air conditioner duct of example 4 can reduce noise also thereby.

### Comparative Example 1

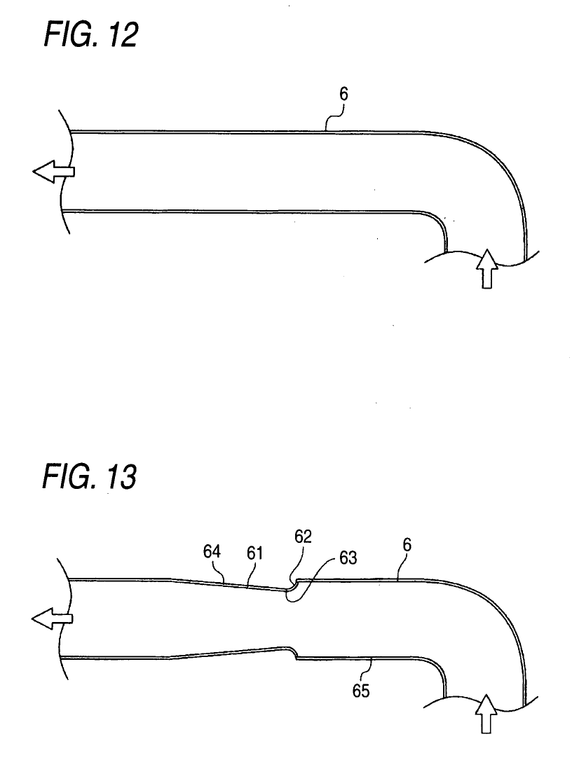

An air conditioner duct of comparative example 1 is constituted only by the outer pipe portion. FIG. 12 shows a view enlarging an essential portion schematically showing a section in an axial direction of the air conditioner duct of comparative example 1.

As shown by FIG. 12, the air conditioner duct of comparative example 1 is constituted only by the outer pipe portion 6. A radial cross-sectional area of the outer pipe portion 6 is constant in the axial direction. In other words, the air conditioner duct of comparative example 1 is not provided with the inner side partitioning portion 43 of the air conditioner duct of example 1, and a portion thereof in correspondence with the inner side partitioning portion 43 is replaced by the adjusting portion 5 of the air conditioner duct of example 1.

### Comparative Example 2

An air conditioner duct of comparative example 2 is constituted only by the outer pipe portion. FIG. 13 shows a view enlarging an essential portion schematically showing a section in an axial direction of the air conditioner duct of comparative example 2.

As shown by FIG. 13, the air conditioner duct of comparative example 2 is constituted only by the outer pipe portion 6. A portion of the outer pipe portion 6 in correspondence with the inner pipe portion 4 of the air conditioner duct of example 1 (diameter contracted portion 61) includes a portion of rapidly reducing a radial cross-sectional area (narrowing rapid change portion 62), a portion of minimizing the radial cross-sectional area (minimum diameter portion 63), and a portion of gradually increasing the radial cross-sectional area (return portion 64) similar to the inner pipe portion 4 of the air conditioner duct of example 1. The diameter contracted portion 61 of the air conditioner duct of comparative example 2 is constituted by a shape substantially the same as that of the inner pipe portion 4 of the air conditioner duct of example 1. A radial cross-section of a portion 65 of the outer pipe portion 6 in correspondence with the adjusting portion 5 of the air conditioner duct of example 1 is constituted by a constant shape similar to that of the adjusting portion 5 of the air conditioner duct of example 1.

### (Noise Measuring Test)

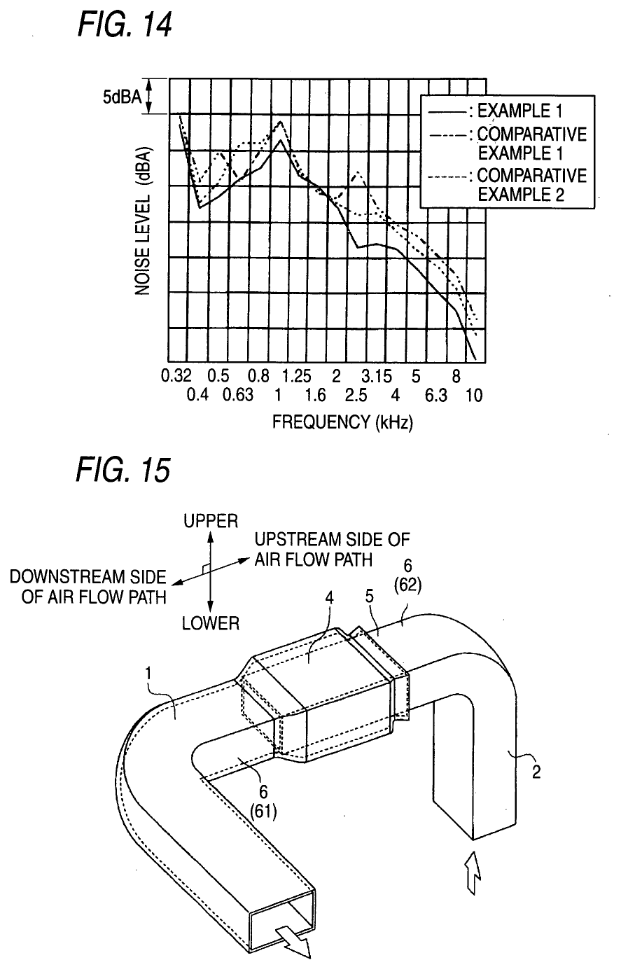

The air conditioner duct of example 1, the air conditioner duct of comparative example 1, and the air conditioner duct of comparative example 2 are attached with a vehicular air conditioning apparatus, and noise is generated by blowing air from the vehicular air conditioner apparatus to the respective ducts for the air conditioner. A microphone is attached to vicinities of downstream sides of air flow paths of the respective ducts of the air conditioner and a noise level (dBA) at frequency 320 Hz through 10000 Hz is measured. FIG. 14 shows a graph showing a result of the noise measuring test. Further, in the graph showing FIG. 14, graduation lines of the ordinate are drawn at intervals of 5 dBA.

As shown by FIG. 14, the air conditioner duct of example 1 considerably reduces noises of respective frequencies more than the air conditioner duct of comparative example 1 and the air conditioner duct of comparative example 2. Particularly, a frequency of noise generated at the vehicular air conditioning apparatus is mainly at a vicinity of 1000 Hz. Therefore, it is known from a result that according to the air conditioner duct of example 1, noise generated at the vehicular air conditioner apparatus can firmly be reduced.

### Example 5

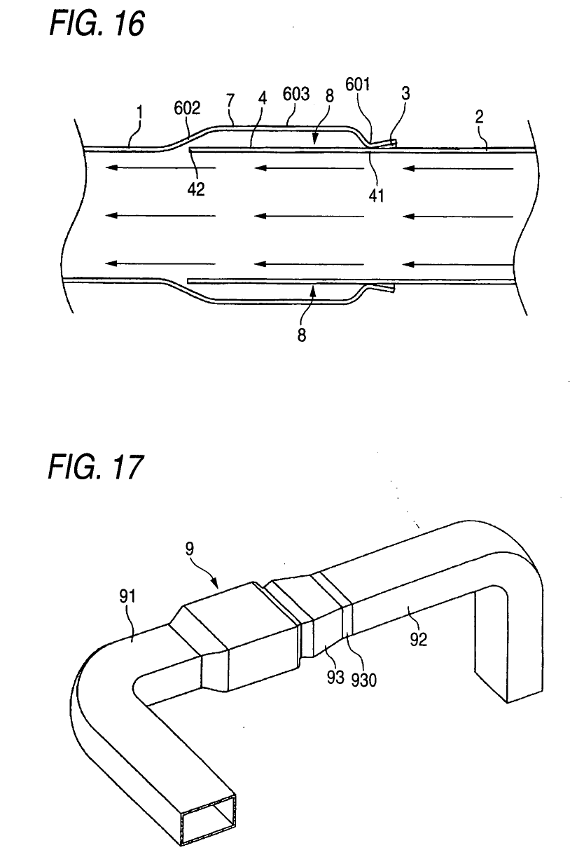

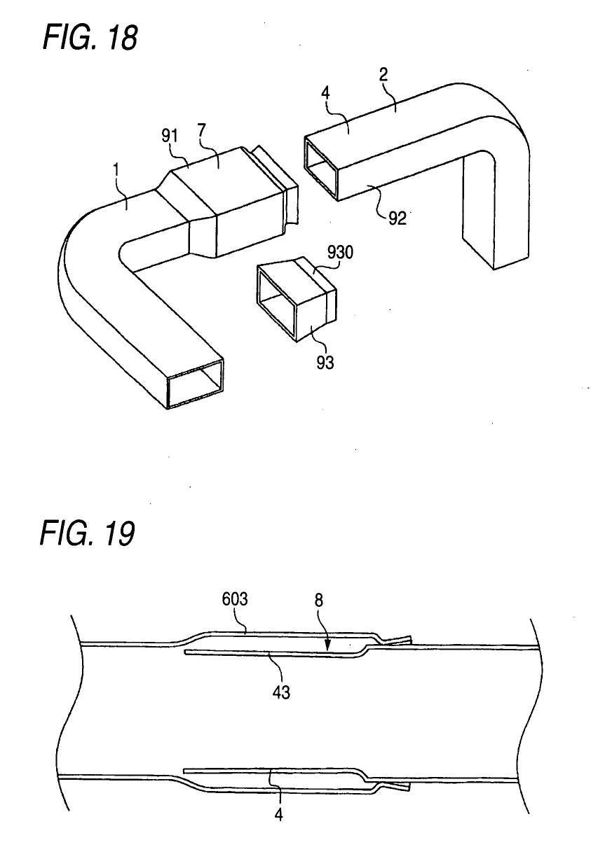

An air conditioner duct of example 5 is provided with (3), (4), (6), (7) mentioned above. FIG. 15 shows a perspective view schematically showing an air conditioner duct of example 5, FIG. 16 shows a view enlarging an essential portion schematically showing a section in an axial direction of the air conditioner duct of example 5. FIG. 17 and FIG. 18 show explanatory views schematically showing a behavior of fabricating the air conditioner duct of example 5.

The air conditioner duct of example 5 is constituted by the first divided member 1 and the second divided member 2 similar to the air conditioner duct of example 1. The first divided member 1 is constituted by the portion of the outer pipe portion 6 on the downstream side of the air flow path of the adjusting portion 5. The second divided member 2 is constituted by integrally molding the portion of the outer pipe portion 6 on the upstream side of the air flow path including the adjusting portion 5, and the inner pipe portion 4. The first divided member 1 and the second divided member 2 are adhered by the adhering member layer 3 to be integrated.

A radial cross-sectional area of the inner pipe portion 4 of the air conditioner duct of example 5 is constant. The outer pipe portion 6 includes the first outer pipe portion 61 and the second outer pipe portion 62 similar to the outer pipe portion of the air conditioner duct of example 1. The first outer pipe portion 61 includes the opposed portion 7 for covering the outer peripheral side of the inner pipe portion 4. The radial cross-sectional area of the opposed portion 7 is larger than the radial cross-sectional area of the end portion on the downstream side of the air flow path of the outer pipe portion 61. The opposed portion 7 includes a first outer end 601 disposed on the outer peripheral side of the first inner end 41, the second outer end 602 disposed on the outer peripheral side of the second inner end 41, and the outer side partitioning portion 603 constituting a portion between the first outer end 601 and the second outer end 602. The outer side partitioning portion 603 is opposed to the inner side partitioning portion 43. The radial cross-sectional area of the outer side partitioning portion 603 is larger than the radial cross-sectional area of the first outer end 601. Therefore, the outer side partitioning portion 603 is constituted by a bulged shape. In other words, the side branch type noise suppressing chamber 8 of the air conditioner duct of example 5 is expanded to the outer peripheral side of the air conditioner duct.

Further, the length in the axial direction and the sectional area of the opening of the side branch type noise suppressing chamber 8 in the air conditioner duct of example 5 are the same as those of the air conditioner duct of example 1. Therefore, the air conditioner duct of example 5 can reduce the restraining object sound by the side branch type noise suppressing chamber 8 similar to the air conditioner duct of example 1.

According to the air conditioner duct of example 5, the side branch type noise suppressing chamber 8 is expanded to the outer peripheral side of the air conditioner duct, and therefore, the radial cross-sectional area of the inner pipe portion 4 can be increased. Therefore, according to the air conditioner duct of example 5, the pressure loss can be restrained from being increased.

Further, the side branch type noise suppressing chamber 8 is extended along the air conditioner duct, and therefore, the air conditioner duct of example 5 is not bulky regardless of providing the side branch type noise suppressing chamber 8.

Further, the radial cross-sectional area of the second outer end 602 is smaller than the radial cross-sectional area of the outer side partitioning portion 603, and therefore, lengths in the radial directions of the inner peripheral face of the opposed portion 7 and the inner peripheral face of the second inner end 42 are small. The air conditioner duct of example 5 can restrain a turbulent flow from being generated also thereby.

A method of fabricating an air conditioner duct of example 5 will be explained as follows.

### (Middle Molding Step)

Similar to the middle molding step of example 1, a parison, not illustrated, is prepared, the parison is put into a blow molding die, not illustrated, and the middle mold member 9 shown in FIG. 17 is blow-molded. The middle mold member 9 is constituted by integrally molding the first divided member scheduled portion 91, the second divided member scheduled portion 92, and the connecting portion 93. The first divided member scheduled portion 91 includes a portion of the outer pipe portion 6 on the downstream side of the air flow path of the adjusting portion 5. The second divided member scheduled portion 92 includes a portion of the outer pipe portion 6 on the upstream side of the air flow path including the adjusting portion 5, and the inner pipe portion 4. The connecting portion 93 is constituted by a shape the same as the connecting portion of the middle mold member 9 of example 1 and includes the preparatory portion 930.

### (Removing Step)

Similar to the removing step of example 1, at least a portion of the connecting portion 93 is removed by cutting the middle mold member 9 provided by the middle molding step to provide the first divided member 1 including the first divided scheduled portion 91, and the second divided member 2 including the second divided member scheduled portion 92 (FIG. 18).

### (Integrating Step)

Similar to the integrating step of example 1, the adhering member layer 3 is laminated on the inner peripheral face of the end portion on the upstream side of the air flow path of the first divided member 1 provided by the removing step. Further, the inner pipe portion 4 of the second divided member 2 is inserted to the inner portion of the first divided member 1 from the end portion on the upstream side of the air flow path of the first divided member 1 to integrate the first divided member 1 and the second divided member 2. The first divided member 1 and the second divided member 2 are adhered by the adhering member layer 3 to be integrated.

The air conditioner duct of example 5 is provided by the middle molding step through the integrating step.

The air conditioner duct of example 5 provided by the fabricating method of example 5 is accurately molded with the inner pipe portion 4 and the opposed portion 7 similar to the air conditioner duct of example 1, and therefore, the duct can reduce the restraining object sound.

Further, by integrally molding the first divided member scheduled portion 91 and the second divided member scheduled portion 92 as the middle mold member 9, the air conditioner duct can inexpensively be fabricated.

Further, since the radial cross-sectional area of the preparatory portion 930 is constant, a plurality of kinds of ducts for air conditioners having different restraining object sounds can be molded by the same molding die.

### Example 6

An air conditioner duct of example 6 is provided with (1) through (4), (6), (7) mentioned above. FIG. 19 shows a view enlarging an essential portion schematically showing a section in an axial direction of the air conditioner duct of example 6.

The inner side partitioning portion 43 of the air conditioner duct of example 6 is constituted by a narrowed shape. Further, the outer side partitioning portion 603 of the air conditioner duct of example 6 is constituted by a bulged shape. Therefore, according to the side branch type noise suppressing chamber 8 of the air conditioner duct of example 6, a portion thereof is expanded to the outer peripheral side of the air conditioner duct and other portion thereof is brought to the inner peripheral side of the air conditioner duct.

The air conditioner duct of example 6 includes the side branch type noise suppressing chamber 8 similar to the ducts for the air conditioners of examples 1 through 5. Therefore, the air conditioner duct of example 6 can reduce the restraining object sound. The side branch type noise suppressing chamber 8 is extended along the air conditioner duct, and therefore, the air conditioner duct of example 6 is not bulky regardless of providing the side branch type noise suppressing chamber 8.

Further, the air conditioner duct of example 6 is provided with a small outer shape since a portion of the side branch type noise suppressing chamber 8 is brought to the inner peripheral side of the air conditioner duct. Further, by expanding a portion of the side branch type noise suppressing chamber 8 to the outer peripheral side of the air conditioner duct, a radial cross-sectional area of the inner pipe portion 4 is large and the pressure loss can be restrained from being increased.

The inner side partitioning portion 43 of the air conditioner duct of example 6 is constituted by a narrowed shape. Therefore, noise transmitted from the vehicular air conditioning apparatus to the air conditioner duct of example 6 is attenuated in passing the inner side partitioning portion 43. The air conditioner duct of example 6 can reduce noise also thereby.

### Example 7

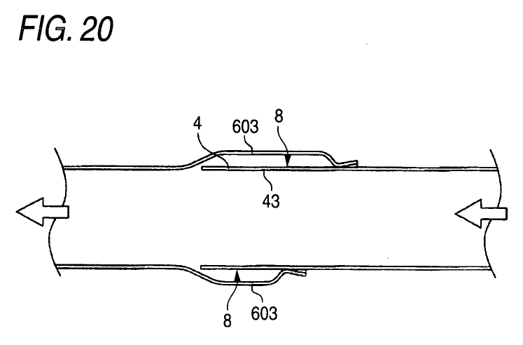

An air conditioner duct of example 7 is provided with (1) through (4), (6), (7) mentioned above. FIG. 20 shows a view enlarging an essential portion schematically showing a section in an axial direction of the air conditioner duct of example 7.

According to the inner side partitioning portion 43 of the air conditioner duct of example 7, similar to that of the air conditioner duct of example 5, the radial cross-sectional area is constant. Further, the outer side partitioning portion 603 of the air conditioner duct of example 7 is constituted by a bulged shape similar to that of the air conditioner duct of example 5. Therefore, the side branch type noise suppressing chamber 8 of the air conditioner duct of example 7 is expanded to the outer peripheral side of the air conditioner duct.

Further, the length in the axial direction of the opposed portion 7 of the air conditioner duct of example 7 differs in the peripheral direction. Therefore, the side branch type noise suppressing chamber 8 of the air conditioner duct of example 7 is provided with a plurality of kinds of lengths l of the side branch type noise suppressor in the above equation 1 similar to the side branch type noise suppressing chamber of the air conditioner duct of example 2. Therefore, according to the air conditioner duct of example 7, a plurality of kinds of restraining object sounds can be reduced.

Further, the side branch type noise suppressing chamber 8 of the air conditioner duct of example 7 is extended along the air conditioner duct, and therefore, the air conditioner duct of example 7 is not bulky regardless of providing the side branch type noise suppressing chamber 8.

Further, according to the air conditioner duct of example 7, by expanding the side branch type noise suppressing chamber 8 to the outer peripheral side of the air conditioner duct, the radial cross-sectional area of the inner pipe portion 7 is large and the pressure loss can be restrained from being increased.

### Example 8

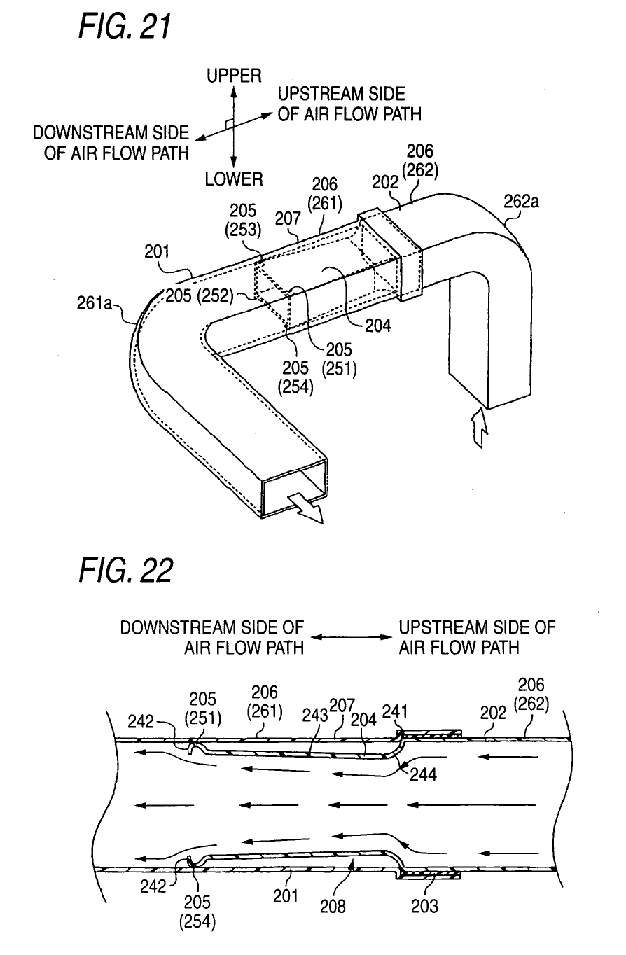

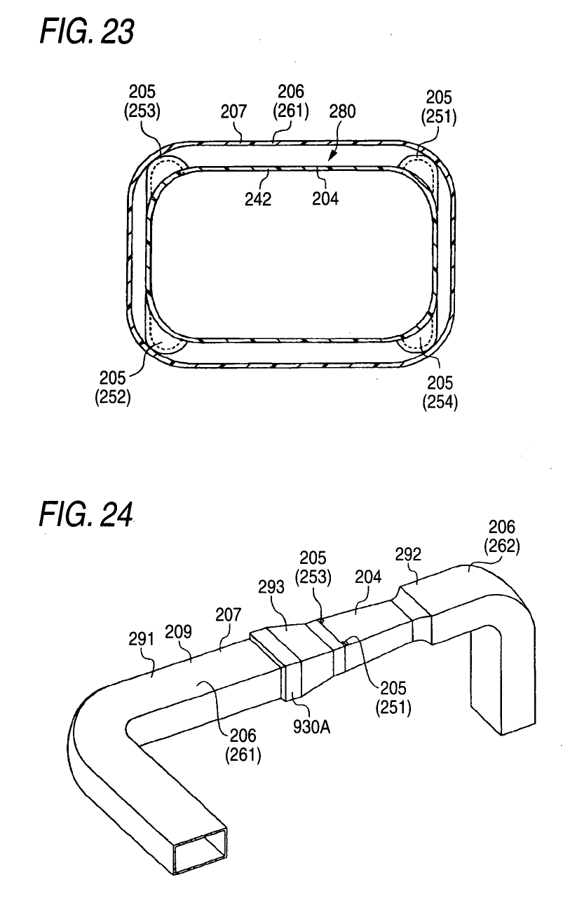

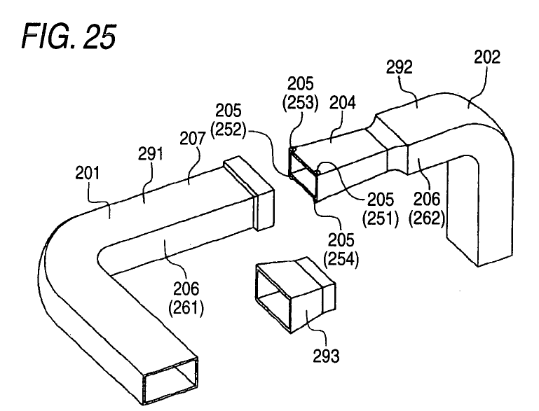

A duct for air conditioning of example 8 includes the above-described (8) through (11). FIG. 21 shows a perspective view schematically showing the duct for air conditioning of example 8. FIG. 22 shows a view enlarging an essential portion schematically showing a section in an axial direction of the duct for air conditioning of example 8. FIG. 23 shows a sectional view schematically showing a section in a diameter direction of the duct for air conditioning of example 8. FIG. 24 through FIG. 25 show explanatory views schematically showing a behavior of fabricating the duct for air conditioning of example 8.

The duct for air conditioning of example 8 is connected to a downstream side of an air flow path of a vehicular air conditioning apparatus (not illustrated). As shown by FIG. 21, the duct for air conditioning of example 8 is constituted by a first divided member 201 substantially in a square cylinder shape and a second divided member 202 substantially in a square cylinder shape. The first divided member 201 constitutes a portion on the downstream side of the air flow path. The second divided member 202 constitutes a portion on an upstream side of the air flow path of the duct for air conditioning.

An end portion of the first divided member 201 on the upstream side of the air flow path is slightly enlarged in a diameter thereof as shown by FIG. 21 and FIG. 22. A portion of the second divided member 202 on the downstream side of the air flow path is smaller in a diameter than a portion of the second divided member 202 on the upstream side of the air flow path and the first divided member 201. A portion of the second divided member 202 on the downstream side of the air flow path is inserted to the portion of the first divided member 201 on the upstream side of the air flow path. As shown in FIG. 22, an inner peripheral face of the end portion of the first divided member 201 on the upstream side of the air flow path is laminated with an adhering member layer 203. The first divided member 201 and the second divided member 202 are adhered by the adhering member layer 203 to be integrated with each other.

An inner cylinder portion 4 of the duct for air conditioning of example 8 is constituted by the portion of the second divided member 202 on the downstream side of the air flow path (that is, the portion of the second divided member 202 inserted to the portion of the first divided member 201 on the upstream side of the air flow path). An outer cylinder portion 206 is constituted by a portion of the second divided member 202 on the upstream side of the air flow path (a portion of the second divided member 202 which is not inserted to an inner portion of the first divided member 201) and the first divided member 201. The second divided member 202 is constituted by integrally molding the portion of the outer cylinder portion 206 on the upstream side of the air flow path and the inner cylinder portion 204.

A portion of the outer cylinder portion 206 constituted by the first divided member 201 is referred to as a first outer cylinder portion 261 and a portion of the outer cylinder portion 206 constituted by the second divided member 202 is referred to as a second outer cylinder portion 262. An opposed face portion 207 is constituted by a portion of the first outer cylinder portion 261 covering an outer peripheral side of the inner cylinder portion 204.

In the following, in the specification, a section in a diameter direction of an inner peripheral face of each portion of the duct for air conditioning is abbreviated simply as a section in a diameter direction. Further, also a sectional area in a diameter direction at the inner peripheral face of each portion of the duct for air conditioning is similarly abbreviated simply as a sectional area in a diameter direction.

A sectional area in a diameter direction of the first outer cylinder portion 261 is substantially constant. The opposed face portion 207 is constituted by a straight cylinder shape. That is, an axis line of the opposed face portion 207 constitutes a linear shape. As shown by FIG. 21, the first outer cylinder portion 261 is provided with a first bent portion 261a in a bent cylinder shape substantially at a center portion in the axial direction. An axis line of the first bent portion 261a constitutes an arc shape.

A sectional area in a diameter direction of the second outer cylinder portion 262 is substantially constant. As shown by FIG. 21; the second outer cylinder portion 262 is provided with a second bent portion 262a in a bent cylinder shape substantially at a center portion in an axial direction. An axis line of the second bent portion constitutes an arc shape.

The inner cylinder portion 204 is provided with a first inner end 241 and a second inner end 242 and an inner side partitioning portion 243 and a spacer portion 205. The first inner end 241 is continuous to the downstream side of the air flow path of the second outer cylinder portion 262 and is integrated to an inner peripheral face of the first outer cylinder portion 261. The second inner end 242 is the end portion of the inner cylinder portion 204 on the downstream side of the air flow path. As shown by FIG. 23, an outer peripheral face of the second inner end 242 and an inner peripheral face of the first outer cylinder portion 261 (inner peripheral face of the opposed face portion 207) are separated from each other and a gap is formed therebetween. The gap constitutes an opening end face 280 of a side branch type silencer chamber 208, mentioned later.

As shown by FIG. 22, the inner side partitioning portion 243 is a portion between the first inner end 241 and the second inner end 242 and connects the first inner end 241 and the second inner end 242. A portion of the inner side partitioning portion 243 proximate to the first inner end 241 is provided with the smallest sectional area in a diameter direction of the inner cylinder portion 204. The portion is referred to as a smallest diameter portion 244. The sectional area in the diameter direction of the inner cylinder portion 204 is rapidly reduced from the first inner end 241 to the smallest diameter portion 244. Further, the sectional area in the diameter direction of the inner cylinder portion 204 is gradually increased from the smallest diameter portion 244 to the second inner end 242. As described above, the outer peripheral face of the second inner end 242 and the inner peripheral face of the first outer cylinder portion 261 (the inner peripheral face of the opposed face portion 207) are separated from each other. Therefore, a sectional area in a diameter direction of the inner side partitioning portion 243 is smaller than a sectional area in a diameter direction of the first inner end 241.

The duct for air conditioning of example 201 is provided with four of the spacer portions 205. The spacer portions 205 are respectively formed at four corners of the second inner end 242. The respective spacer portions 205 are projected in a direction of an outer periphery of the inner cylinder portion 204. The inner cylinder portion 204 is arranged at an inner portion of the outer cylinder portion 206 (that is, inner portion of the opposed face portion 207), and therefore, the respective spacer portions 205 are projected to the opposed face portion 207. Further, front ends of the respective spacer portion 205 are brought into contact with an inner peripheral face of the opposed face portion 207. A first spacer portion 251 and a second spacer portion 252 which are two of the four spacer portions 205 are arranged symmetrically by interposing the axis line of the opposed face portion 207. Further, a third spacer portion 253 and a fourth spacer portion 254 which are other two of the four spacer portions 205 are symmetrically arranged by interposing the axis line of the opposed face portion 207. Therefore, the duct for air conditioning of example 8 is provided with two pairs of the spacer portion 205.

As shown by FIG. 22, a space is formed between the outer peripheral face of the inner cylinder portion 204 and the inner peripheral face of the opposed face portion 207. The space is communicated with an inner peripheral side of the inner cylinder portion 204 by way of a gap between the outer peripheral face of the second inner end 242 and the inner peripheral face of the opposed face portion 207 (that is, the opening end face 280 shown in FIG. 23). Therefore, according to the duct for air conditioning of example 8, the side branch type silencer chamber 208 is partitioned by the inner cylinder portion 204 and the opposed face portion 207. Therefore, the duct for air conditioning of example 8 can reduce noise by the side branch type silencer chamber 208.

Further, the spacer portions 205 formed at the inner cylinder portion 204 are brought into contact with the inner peripheral face of the opposed face portion 207. Therefore, even when the inner cylinder portion 204 or the outer cylinder portion 206 are not molded highly accurately and lengths in the diameter direction thereof are dispersed, a position in a diameter direction of the inner cylinder portion 204 relative to the opposed face portion 207 is restricted by the spacer portions 205. Therefore, the distance in the diameter direction between the outer peripheral face of the inner cylinder portion 204 and the inner peripheral face of the opposed face portion 207 at the opening end face 280 is difficult to be dispersed. Therefore, the duct for air conditioning of example 8 is excellent in a function of reducing restraining object sound.

Further, the spacer portions 205 in the duct for air conditioning of example 8 are formed at the second inner end 242 of the inner cylinder portion 204, and therefore, the distance in the diameter direction between the outer peripheral face of the inner cylinder portion 204 and the inner peripheral face of the opposed face portion 207 at the opening end face 280 is further difficult to be dispersed. Also thereby, the duct for air conditioning of example 8 is excellent in the function of reducing the restraining object sound.

Further, the duct for air conditioning of example 8 is provided with two pairs of the spacer portions 205, and the paired spacer portions 205 (first spacer portion 251 and the second spacer portion 252, the third spacer portion 253 and the fourth spacer portion 254) are arranged respectively at positions symmetrical with each other by interposing the axis line of the opposed face portion 207. Therefore, the spacer portion 205 can fix the inner cylinder portion 204 to the opposed face portion 207 in the diameter direction. Therefore, according to the duct for air conditioning of example 8, the distance between the outer peripheral face of the inner cylinder portion 204 and the inner peripheral face of the opposed face portion 207 at the opening end face 280 is difficult to be dispersed. Also thereby, the duct for air conditioning of example 8 is excellent in the function of reducing the restraining object sound.

Further, the spacer portions 205 are formed at the four corners of the inner cylinder portion 204, and therefore, the spacer portions 205 are difficult to deform. Because the four corners of the inner cylinder portion 204 constituting the square cylinder shape are excellent in the strength. Therefore, according to the duct for air conditioning of example 8, the position in the diameter direction of the inner cylinder portion 204 relative to the opposed face portion 207 can further firmly be restricted by the spacer portions 205.

Further, the spacer portions 205 are formed at the inner cylinder portion 204, and therefore, the spacer portions 205 are excellent in dimensional accuracies. Further, by forming the spacer portions 205 at the inner cylinder portion 204, even when a position of integrating the first divided member and the second divided member is shifted in the axial direction, the spacer portions 205 are brought into contact with the inner peripheral face of the opposed face portion 207 with high reliability. Therefore, according to the duct for air conditioning of example 8, the distance in the diameter direction between the outer peripheral face of the inner cylinder portion 204 and the inner peripheral face of the opposed face portion 207 at the opening end face 280 is further difficult to be dispersed, further, the position in the diameter direction of the inner cylinder portion 204 relative to the opposed face portion 207 can further firmly be restricted by the spacer portions 205. Also thereby, the duct for air conditioning of example 8 is further excellent in the function of reducing the restraining object sound.

Further, although the spacer portions 205 of the duct for air conditioning of example 8 are formed at the second inner end 242 of the inner cylinder portion 204, the spacer portion 205 of the duct for air conditioning of the invention may be formed at the inner side partitioning portion 243, or may be formed at the opposed face portion 207.

The method of fabricating the duct for air conditioning of example 8 will be explained as follows.

### (Middle Molding Step)

First, a parison (not illustrated) comprising PE, PP or the like is prepared. The parison is put into a blow-molding die, not illustrated, and a middle molding member 209 shown in FIG. 24 is blow-molded. The middle molding member 209 is constituted by integrally molding a first divided member scheduled portion 291, a second divided member scheduled portion 292, and a connecting portion 293. The first divided member scheduled portion 291 includes the first outer cylinder portion 261. The second divided member scheduled portion 292 includes the second outer cylinder portion 262 and the inner cylinder portion 204. The spacer portion 205 is included in the second divided member scheduled portion 292, and the opposed face portion 207 is included in the first divided member scheduled portion 291.

One end of the connecting portion 293 is integrated with an end portion of the first divided member scheduled portion 291 on the upstream side of the air flow path. Other end of the connecting portion 293 is integrated with an end portion of the second divided member scheduled portion 292 on the downstream side of the air flow path. A portion of the connecting portion 293 on a side of the first divided member scheduled portion 291 is larger than a portion thereof on a side of the second divided member scheduled portion 292 in a sectional area in a diameter direction. The portion of the connecting portion 293 on the side of the second divided member scheduled portion 292 (referred to as preparatory portion 930A) is provided with a constant sectional area in the diameter direction.

### (Removing Step)

By cutting the middle molding member 209 provided by the middle molding step and removing at least a portion of the connecting portion 293 from the middle molding member 209, the first divided member 201 including the first divided member scheduled portion 291 and the second divided member 202 including the second divided member scheduled portion 292 are provided (FIG. 25). Further, in cutting the middle molding member 209, a cutting position is positioned by touching a jig, not illustrated, to the middle molding member 209.

### (Integrating Step)

The adhering member layer 203 is laminated on the inner peripheral face of the end portion of the first divided member 201 provided by the removing step on the upstream side of the air flow path. Further, the inner cylinder portion 204 of the second divided member 202 is inserted to the inner portion of the first divided member 201 from the end portion of the first divided member 201 on the upstream side of the air flow path to integrate the first divided member 201 and the second divided member 202. The adhering member layer 203 laminated on the end portion of the first divided member 201 on the upstream side of the air flow path is pasted to the outer peripheral face of the end portion of the second outer cylinder portion 262 on the downstream side of the air flow path. Therefore, the first divided member 201 and the second divided member 202 are adhered by the adhering member layer 203 to be integrated.

The duct for air conditioning of example 8 is provided by the middle molding step through the integrating step mentioned above.

According to the method of fabricating the duct for air conditioning of example 8, the first divided member 201 having the opposed face portion 207 and the second divided member 202 separate from the first divided member 201 having the inner cylinder portion 204 are fixed to be integrated. Therefore, according to the method of fabricating the duct for air conditioning of example 201, the inner cylinder portion 204 and the opposed face portion 207 can easily be molded. Therefore, according to the method of fabricating the duct for air conditioning of example 8, the duct for air conditioning capable of reducing the restraining object sound can inexpensively be fabricated.

Further, by integrally forming the spacer portions 205 at the inner cylinder portion 204, the duct for air conditioning can inexpensively be fabricated in comparison with a case of assembling to integrate, for example, the spacer portion 205 formed separately from the inner cylinder portion 204 to the inner cylinder portion 204.

Further, by integrally molding the first divided member scheduled portion 291 and the second divided member scheduled portion 292 as the middle molding member 209, the first divided member scheduled portion 291 mainly constituting the first divided member 201 and the second divided member scheduled portion 292 mainly constituting the second divided member 202 can be molded by the same molding die (blow die). Therefore, according to the method of fabricating the duct for air conditioning of example 8, cost required for the molding die can be reduced and the duct for air conditioning can inexpensively be fabricated.

Further, although according to the method of fabricating the duct for air conditioning of example 8, the first divided member 201 having the opposed face portion 207 and the second divided member 202 having the inner cylinder portion 204 are integrally blow-molded, the opposed face portion 207 and the inner cylinder portion 204 may separately be blow-molded.

### Example 9

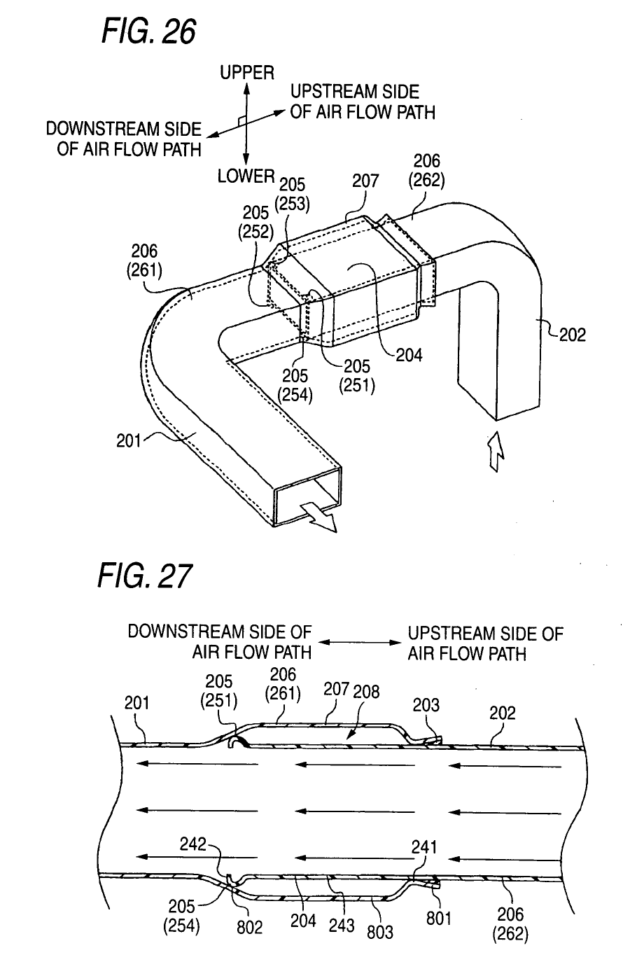

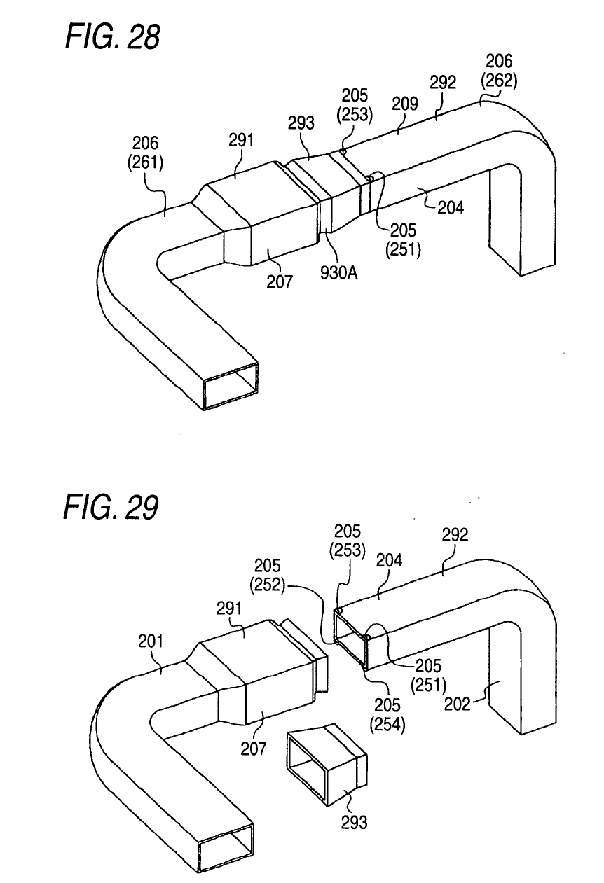

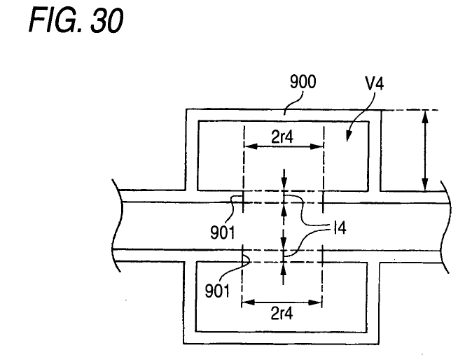

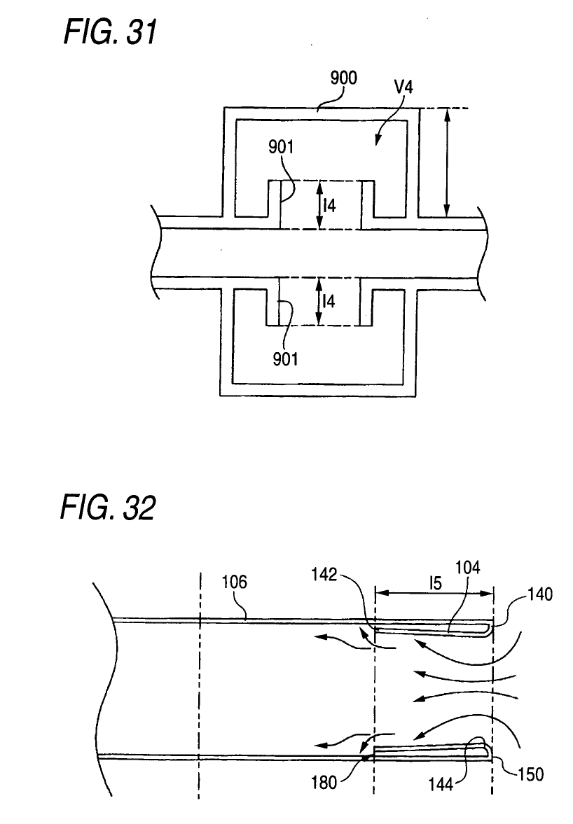

A duct for air conditioning of example 202 is provided with (8) through (11) mentioned above. FIG. 26 shows a perspective view schematically showing the duct for air conditioning of example 9. FIG. 27 shows a view enlarging essential portions schematically showing a section in an axial direction of the duct for air conditioning of example 9. FIG. 28 through FIG. 29 show explanatory views schematically showing a behavior of fabricating the duct for air conditioning of example 9.

The duct for air conditioning of example 9 is constituted by the first divided member 201 and the second divided member 202 similar to the duct for air conditioning of example 8 (FIG. 26 through FIG. 27). The first divided member 201 is constituted by the portion of the outer cylinder portion 206 on the downstream side of the air flow path. The second divided member 202 is constituted by integrally molding the portion of the outer cylinder portion 206 on the upstream side of the air flow path and the inner cylinder portion 204. The opposed face portion 207 is included in the first divided member. The first divided member 201 and the second divided member 202 are adhered by the adhering member layer 203 to be integrated similar to example 8.

The sectional area in the diameter direction of the inner cylinder portion 204 of the duct for air conditioning of example 9 is constant. The spacer portions 205 are formed at the four corners of the inner cylinder portion 204 similar to the spacer portions 205 of example 8.

The outer cylinder portion 206 is provided with the first outer cylinder portion 261 and the second outer cylinder portion 262 similar to the outer cylinder portion of example 8. The first outer cylinder portion 261 is provided with the opposed face portion 207 for covering the outer peripheral side of the inner cylinder portion 204. The sectional area in the diameter direction of the opposed face portion 207 is larger than the sectional area in the diameter direction of the end portion of the first outer cylinder portion 261 on the downstream side of the air flow path. The opposed face portion 207 is provided with a first outer end 801 disposed on the outer peripheral side of the first inner end 241, a second outer end 802 disposed on the outer peripheral side of the second inner end 242, and an outer side partitioning portion 803 constituting a portion between the first outer end 801 and the second outer end 802. The outer side partitioning portion 803 is opposed to the inner side partitioning portion 243. A largest sectional area in a diameter direction of the outer side partitioning portion 803 is larger than a sectional area in a diameter direction of the first outer end 801 and a sectional area in a diameter direction of the second outer end 802. Therefore, the outer side partitioning portion 803 constitutes a bulged shape. In other words, the side branch type silencer chamber 208 in the duct for air conditioning of example 9 is expanded to an outer peripheral side of the duct for air conditioning.

The length in the axial direction and the opening end area of the side branch type silencer chamber 208 of the duct for air conditioning of example 9 are the same as those of the duct for air conditioning of example 8. Therefore, the duct for air conditioning of example 9 can reduce the restraining object sound by the side branch type silencer chamber 208 similar to the duct for air conditioning of example 8.

Further, the spacer portion 205 formed at the inner cylinder portion 204 is brought into contact with the inner peripheral face of the opposed face portion 207, and therefore, the distance in the diameter direction between the outer peripheral face of the inner cylinder portion 204 and the inner peripheral face of the opposed face portion 207 at the opening end face 280 is difficult to be dispersed. Therefore, the duct for air conditioning of example 9 is excellent in the function of reducing the restraining object sound.

Further, the duct for air conditioning of example 9 is provided with two pairs of the spacer portions 205, and the paired spacer portions 205 (the first spacer portion 251 and the second spacer portion 252, the third spacer portion 253 and the fourth spacer portion 254) are respectively arranged at positions symmetrical with each other by interposing the axis line of the opposed face portion 207. Also thereby, the duct for air conditioning of example 9 is excellent in the function of reducing the restraining object sound.

Further, the spacer portions 205 are formed at four corners of the inner cylinder portion 204 and are difficult to deform. Also thereby, the duct for air conditioning of example 9 is excellent in the function of reducing the restraining object sound.

A method of fabricating the duct for air conditioning of example 9 will be explained as follows.

### (Middle Molding Step)

Similar to the middle molding step of example 8, a parison, not illustrated, is prepared, the parison is put into a blow-molding die, not illustrated, and the middle molding member 209 shown in FIG. 28 is blow-molded. The middle molding member 209 is constituted by integrally molding the first divided member scheduled portion 291, the second divided member scheduled portion 292, and the connecting portion 293. The first divided member scheduled portion 291 includes the first outer cylinder portion 261. The second divided member scheduled portion 292 includes the second outer cylinder portion 262 and the inner cylinder portion 204. The connecting portion 293 is constituted by a shape the same as that of the connecting portion of the middle molding member 209 of example 8 and is provided with the preparatory portion 930A.

### (Removing Step)

Similar to the removing step of example 8, at least a portion of the connecting portion 293 is removed by cutting the middle molding member 209 provided by the middle molding step to provide the first divided member 201 including the first divided member scheduled portion 291 and the second divided member 202 including the second divided member scheduled portion 292 (FIG. 29).

### (Integrating Step)

Similar to the integrating step of example 8, the adhering member layer 203 is laminated on the inner peripheral face of the end portion of the first divided member 201 provided by the removing step on the upstream side of the air flow path. Further, the inner cylinder portion 204 of the second divided member 202 is inserted from the end portion of the first divided member 201 on the upstream side of the air flow path to the inner portion of the first divided member 201 to integrate the first divided member 201 and the second divided member 202. The first divided member 201 and the second divided member 202 are adhered by the adhering member layer 203 to be integrated.

The duct for air conditioning of example 9 is provided by the middle molding step through the integrating step mentioned above.

According to the method of fabricating the duct for air conditioning of example 9, by forming the spacer portion 205 integrally with the inner cylinder portion 204, the duct for air conditioning can inexpensively be fabricated.

Further, according to the method of fabricating the duct for air conditioning of example 9, similar to the method of fabricating the duct for air conditioning of example 8, the inner cylinder portion 204 and the opposed face portion 207 can easily be formed, and therefore, the duct for air conditioning of example 9 can inexpensively be fabricated. Further, by also forming the spacer portion 205 integrally with the inner cylinder portion 204, the duct for air conditioning of example 1 can inexpensively be fabricated. Further, also by integrally molding the first divided member scheduled portion 291 and the second divided member scheduled portion 292 as the middle molding member 209, the duct for air conditioning of example 9 can inexpensively be fabricated.

What is claimed is:

1. An air conditioner duct connected to a downstream side of an air flow path of a vehicular air conditioning apparatus, the duct comprising:
an outer pipe portion constituting a tubular shape;
an inner pipe portion constituting a tubular shape, formed at an inner portion of the outer pipe portion, a first inner end constituting one end in an axial direction being integrated to an inner peripheral face of the outer pipe portion, a second inner end constituting other end in the axial direction being arranged on a downstream side of an air flow path of the first inner end, and an outer peripheral face of the second inner end being separated from an inner peripheral face of the outer pipe portion; and
a side branch type noise suppressing chamber defined by the inner peripheral face of the outer pipe portion and the outer peripheral of the inner pipe portion;
wherein the outer pipe portion includes an adjusting portion continuous to an upstream side of the air flow path of the first inner end.

2. The duct for an air conditioner according to claim 1, wherein the inner pipe portion includes an inner side partitioning portion constituting a portion between the first inner end and the second inner end;
wherein a sectional area in a diameter direction of an inner peripheral face of the inner side partitioning portion is smaller than a sectional area in a diameter direction of an inner peripheral face of the first inner end; and
wherein a section in a diameter direction of an inner peripheral face of the adjusting portion is constituted by a constant shape.

3. The duct for an air conditioner according to claim 2, a sectional area in the diameter direction of the inner peripheral face of the second inner end is larger than a sectional area in the diameter direction of the inner peripheral face of the inner side partitioning portion.

4. The duct for an air conditioner according to claim 1, wherein the outer pipe portion includes a first outer end disposed on an outer peripheral side of the first inner end, a second outer end disposed on an outer peripheral side of the second inner end, and an outer side partitioning portion constituting a portion between the first outer end and the second outer end; and
wherein a radial cross-sectional area of an inner peripheral face of the outer side partitioning portion is larger than a radial cross-sectional area of an inner peripheral face of the first outer end.

5. The duct for an air conditioner according to claim 4, wherein a radial cross-sectional area of an inner peripheral face of the second outer end is smaller than the radial cross-sectional area of the inner peripheral face of the outer side partitioning portion.

6. The duct for an air conditioner according to claim 1, wherein the inner pipe portion includes an erected wall projected from the outer peripheral face of the inner pipe portion to the inner peripheral face of the outer pipe portion;
wherein a projected end face of the erected wall is separated from the inner peripheral face of the outer pipe portion;
wherein the erected wall is extended in a direction of being intersected with an axis line of the inner pipe portion; and
wherein a distance in an axial direction between a first erected end constituting one end of the erected wall and the first inner end, and a distance in the axial direction between a second erected end constituting other end of the erected wall and the first inner end differ from each other.

7. The duct for an air conditioner according to claim 2, wherein a length in the axial direction of the adjusting portion is equal to or larger than 30 mm.

8. The duct for an air conditioner according to claim 6, wherein a length in the axial direction of the adjusting portion is equal to or larger than 30 mm.

9. The duct for an air conditioner according to claim 1, further comprising:
a first divided member including a portion of the outer pipe portion on the downstream side of the air flow path of the adjusting portion; and
a second divided member including a portion of the outer pipe portion on the upstream side of the air flow path including the adjusting portion and the inner pipe portion and constituted by integrally molding the first divided member and the second divided member;
wherein the inner pipe portion of the second divided member is inserted to an inner portion of the first divided member and the first divided member and the second divided member are fixedly attached to be integrated to each other.

10. A duct for air conditioning constituted by being blow-molded and connected to a downstream side of an air flow path of a vehicular air conditioning apparatus, the duct for air conditioning including:
an outer cylinder portion constituting a cylinder shape;
an inner cylinder portion constituted by a cylinder shape, arranged at an inner portion of the outer cylinder portion, a first inner end constituting one end in an axial direction being integrated to an inner peripheral face of the outer cylinder portion, a second inner end constituting other end in the axial direction being arranged on the downstream side of the air flow path of the first inner end, and an outer peripheral face of the second inner end and the inner peripheral face of the outer cylinder portion being separated from each other; and
a side branch type silencer chamber partitioned by the inner peripheral face of the outer cylinder portion and an outer peripheral face of the inner cylinder portion;
wherein the inner cylinder portion and an opposed face portion constituted by a portion of the outer cylinder portion for covering an outer peripheral side of the inner cylinder portion comprise separately and assembled to integrate; and
wherein at least one of the opposed face portion and the inner cylinder portion is formed with a spacer portion projected to other thereof.

11. The duct for air conditioning according to claim 10, wherein the spacer portion is formed at least one of the opposed face portion and the inner cylinder portion and is brought into contact with other thereof.

12. The duct for air conditioning according to claim 10, wherein at least a pair of the spacer portions are formed and the paired spacer portions are arranged symmetrically with each other by interposing an axis line of the opposed face portion.

13. The duct for air conditioning according to claim 10, wherein the spacer portion is formed at the inner cylinder portion.

14. The duct for air conditioning according to claim 10, wherein the spacer portion is formed at the second inner end of the inner cylinder portion.
